(19) United States
(12) Patent Application Publication
(10) Pub. No.: US 2024/0227985 A1
(43) Pub. Date: Jul. 11, 2024

(54) TETHERED POWER GENERATING BUOY SYSTEM

(71) Applicant: TRITON SYSTEMS, INC., Chelmsford, MA (US)

(72) Inventors: Tyler ROBERTSON, North Attleboro, MA (US); Steven TRVALIK, Arlington, MA (US); Charles HANNON, Arlington, MA (US); David AUBREY, Pocasset, MA (US); Allan CHERTOK, Bedford, MA (US); Tyson LAWRENCE, Highlands Ranch, CO (US)

(21) Appl. No.: 18/469,145

(22) Filed: Sep. 18, 2023

Related U.S. Application Data
(60) Provisional application No. 63/376,018, filed on Sep. 16, 2022.

(51) Int. Cl. B63B 21/20; F03B 13/18

(52) U.S. Cl. CPC B63B 21/20; F03B 13/1875

(57) ABSTRACT

Disclosed herein are systems employing a power generating buoy separate from a host buoy but connected via tether, allowing the power generating buoy to be distant from the host buoy (e.g. an observational buoy) so as to minimize the impact of the power generating buoy on the host buoy. The tether is connected at one end to the power generating buoy and connectable to a floating host buoy, wherein the tether further comprises means for transferring power generated by the power-generating buoy to the host buoy; and wherein the tether is adapted to allow for independent movement of the power-generating buoy relative to the host buoy, and has no substantial hydrodynamic effect on or from the host buoy when connected.

### CROSS-REFERENCE TO RELATED APPLICATIONS

This application is a Non-Provisional Patent application which claims priority to U.S. Provisional Patent Application No. 63/376,018 filed Sep. 16, 2022, which is incorporated by reference herein in its entirety.

### GOVERNMENT INTEREST

This invention was made with Government support under Department of Energy Contract No. DE-SC0020830. The Government has certain rights in this invention.

### BACKGROUND

Increasingly used by government, industry, and non-profit entities, the term “blue economy” is used to capture the role between economic, social, and ecological sustainability of the ocean. Among many applications of the blue economy is the use of marine and hydrokinetic energy to provide power at sea in support of ocean observation and navigation. Wave power is an attractive source of renewable energy due to its consistent availability as compared to wind and solar, particularly during winter months when surface waves are more active while days are shorter with less available solar energy.

With the growth of the Blue Economy, the volume of data collection within the ocean environment has been rapidly increasing. Larger numbers of oceanographic, meteorological, and floating LiDAR, and other, buoys have been collecting high fidelity measurements while pushing against power budget limits. Power limitations lead to infrequent transmission of reduced data sets or recording data to local storage that must be physically collected when the buoy is serviced. Current floating LiDAR, and other, buoys rely on solar, wind, fueled generators, and fuel cell power which are subject to intermittency and damage, and routine servicing is also required to replace battery packs and refuel diesel generators.

Existing WECs target high-power applications, relying on large, expensive form factors that are not cost-effective to scale for use with moored instrumentation, such as ocean observation buoys.

There are no commercially available small-scale wave energy converters in the 0-1 kW range. Previous attempts have been unsuccessful.

Accordingly, there is a need for small scale systems, providing up to about 1 kW watts of auxiliary power based on instrumentation requirements.

### SUMMARY

Disclosed herein are apparatus and systems adapted to provide and transfer power from a power-generating buoy to another floating body (e.g. a host buoy), without substantially affecting the hydrodynamics of either. Generally, the system includes a power generating buoy and a tether, wherein the tether is adapted for connection to a host buoy such that the power generating buoy and the host buoy with minimal impact on hydrodynamic. For example, the tether is affixed to both the power buoy and the host buoy such that the tether is compliant in multiple modes of motion. The tether is also designed to prevent the two floating bodies from contacting one another.

Disclosed herein is a wave energy capture system comprising a wave energy capture buoy, and a tether comprising a stretch hose connected at one end to the wave energy capture buoy and connectable to a host buoy, wherein the tether further comprises means for transferring power generated by the wave energy capture buoy to the host buoy as well as data transmitted between the buoys; and wherein the tether is adapted to allow for independent movement of the wave energy capture buoy relative to the host buoy, and has no substantial effect on one or more of the movement of or measurements made by the host buoy.

Also disclosed herein is an observational buoy system, comprising a host buoy that is an observational bouy; a wave energy capture buoy, and a tether comprising a stretch hose interconnecting the host buoy and the wave energy capture buoy, wherein the tether is adapted to allow for independent movement of the wave energy capture buoy relative to the host buoy, and has no substantial effect on one or more of the movement of or measurements made by the host buoy.

Also disclosed herein is a wave energy capture buoy including an improved seal, improved piston, or combination thereof.

Also disclosed are testing methods and apparatus developed and used for implementing the concepts herein.

### BRIEF DESCRIPTION OF THE DRAWINGS

FIG. 1A and FIG. 1B: WEC tethered to observation bouy (FIG. 1A) and LiDAR buoy (FIG. 1B).

FIG. 2A schematic illustration of pressure oscillations

FIG. 2B: Total pressure at depth=0 m, −5 m, −10 m, and −15 m for wave height=2 m, wavelength=50 m

FIG. 3: 5 m Compliant Tether for WEC

FIG. 4: Retrofit Bracket for an EOM Whale Listening Buoy

FIG. 5: Tension vs Elongation of 5 m Compliant Tether

FIG. 6: Camera Location 1

FIG. 7: Buoy at each position in circular movement with wave.

FIG. 8: Testing Matrix

FIG. 9: Test 55 string pot measurement

FIG. 10: Test 55 Buoy motion following

FIG. 11: Test 103 Data

FIG. 12: Test 103 power data

FIG. 13: Variation of piston ratio with height

FIG. 14: Variation of piston ratio with wave period

FIG. 15: Variation of Piston Ratio with Damping Force

FIG. 16: Variation of mean power capture with damping force

FIG. 17A-FIG. 17C: ProteusDS Simulation with NOMAD Buoy and WEC Buoy

(FIG. 17A), EOM Compliant Cable Production (FIG. 17B and FIG. 17C).

FIG. 18: EOM ProteusDS Simulation

FIG. 19A-FIG. 19B: WED-Sim block diagram (FIG. 19A) Physical model (FIG. 19B)

### DETAILED DESCRIPTION

Disclosed herein are apparatus and systems adapted to provide and transfer power from a power-generating buoy to another floating body (e.g. a host buoy), without substantially affecting the hydrodynamics of either. Generally, the system includes a power generating buoy and a tether, wherein the tether is adapted for connection to a host buoy such that the power generating buoy and the host buoy with minimal impact on hydrodynamic. For example, the tether is affixed to both the power buoy and the host buoy such that the tether is compliant in multiple modes of motion. The tether is also designed to prevent the two floating bodies from contacting one another.

This disclosure relates to specific power generating buoys and to observation type buoys, but may be implemented between any two floating buoys, and may employ multiple power generating buoys. For example, Tether the power generating buoy to a more massive object (such as a floating off-shore aquaculture pen) where it is important to maintain the hydrodynamic response of the WEC buoy to maximize wave energy capture.

In another system, a two-dimensional array of power buoys where buoys may be used. Each may be connected to the host floating body or may be interconnected to aggregate collected power and transmit data signals for monitoring. Each buoy is hydrodynamically free to heave and move while not interfering with neighbors. This arrangement could serve a larger power demand. Tether needs to provide spacing and prevent damage to buoys.

Disclosed herein is a retrofittable power-generating buoy system capable of providing auxiliary power to observation, or other, buoys or floating host bodies to increase mission duration, power budget, improve reliability, and/or reduce the need for service trips.

The power-generating buoy may use any suitable means for generating power, including but not limited to Wave Energy Converter (WEC), solar, wind, fuel-based generator, etc. This disclosure focuses heavily on WEC based power-generating buoys and observation buoys, because of the heightened need for independent hydrodynamics for such systems.

Observation/Instrumentation buoys are often limited by available power. The Wave Energy Converter system disclosed herein harvests mechanical wave energy and converts it to useable electricity. This electrical power can allow for longer science missions, more sensors, more communications, and reduced maintenance.

One of the greatest challenges has been developing a method to interface a WEC with these buoys without impacting measurement fidelity. This is especially critical for inertial wave and LiDAR wind measurements collected with sensors that could be adversely affected by additional buoy dynamics introduced by an integrated WEC. To address this, the disclosed systems include a compliant tether to pair an observation buoy with a floating WEC while decoupling relative motion. Based on proven stretch hose technology, this compliant tether transmits power and data between the buoy-WEC system with minimal adverse effect on oceanographic, meteorological, wind resource characterization, and other measurements.

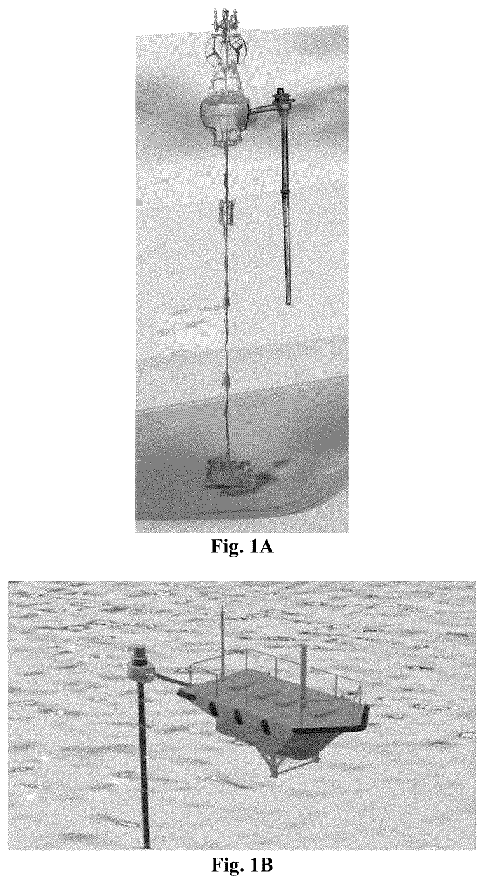

An integrated WEC may disrupt existing sensors and negatively impact the fidelity of wave and LiDAR wind measurements. Thus, integrating a WEC power source into existing observation buoys is not ideal. Accordingly, disclosed herein is a floating WEC buoy with a compliant electromechanical tether to secure an auxiliary WEC to an observation buoy while allowing for transfer of power and data. An example of this configuration is shown in FIG. 1A and FIG. 1B. This floating WEC freely follows wave motion and does not require a second reactionary body or fixed anchor line to generate power. The compliant tether exerts minimal force on the observation buoy, preserving the fidelity of wave, wind, and other measurements. The compliant tether also allows the floating WEC to be retrofit to existing buoys with minimal modifications, leading to a greater potential for adoption.

This Wave Energy Converter system provides auxiliary power to these buoys and may integrate with existing power systems such as batteries, fuel cells, solar, and wind power. This system is easily retrofittable through a compliant tether made from a stretch hose. This tether allows for additional power generation without requiring modification or space on the observation buoy (i.e. host buoy) and without significantly impacting the motion of the observation buoy. This preserves measurement fidelity, which is necessary for inertial and LiDAR measurements.

There are no commercially available small-scale wave energy converters in the 0-500 W range. Previous attempts have been unsuccessful. Use of a tether to attach the power generating buoy to the host buoy is a novel approach facilitating market adoption in an attractive niche market with a verified need for a new power generation solution.

The system disclosed here comprises an independent power generating buoy connected via a tether to a floating body requiring power (e.g. host buoy). For increased system reliability, the WEC easily integrates with additional, existing power systems such as solar panels, batteries, small wind turbines, fuel fired generators, or any other combination of power generating approach and energy storage options.

A tether connects the two floating bodies—that is, the host buoy and the floating WEC buoy. This tether could be rigid, semi-rigid, or flexible, and be elastic or inelastic. A flexible connection allows the two floating bodies to move independently maintaining seaworthiness and motion characteristics while allowing power and data transfer. One embodiment employs an elastic hose (e.g. a stretch hose) to separate motion while also maintaining a set distance between the bodies and providing a conduit through which data and power cables can travel. This disclosure focuses on the use of an elastic hose or stretch hose as the tether. Other systems can also be used. Such systems may employ one or more of springs, single or multi direction rotational joints such as hinges, ball joints, and universal joints to further decouple the two bodies and control relative location and motion. The joints could be freely moving, elastic, spring loaded to return to a chosen position, etc. Sections of rigid pipe combined with flexible joints may provide similar performance to an elastic hose. Power and data cables could also wrap around the outside of the tether, be integrated into its structure, or run independently between the two bodies. Wireless power and data transfer could also be used. The tether may need to be resistant to fish attack or biofouling and could include coatings, impact resistant layers, or other antifouling technologies. Any material or composite structure can be used to construct the tether.

Weights, drogues, and floats may be used to control tether position and motion. In particular, use of a weight or section of chain between two floats could be desirable to create a catenary between the two bodies and further decouple motion. A drogue at the weight can be used to add damping.

It may be desirable to use a plurality of connections between the two bodies to better control relative position and orientation. Multiple tethers could run in parallel or at any angle to each other. It may be desirable to insert one or more rigid separators between the tethers in between the two bodies in order to keep the tethers separated to avoid tangling and better control forces. The separators could be wider than the distance between tethers at their attachment point. In the preferred embodiment the tether or tethers would only be at the surface, however the tether or tethers could also be subsurface to better control position and loading. Subsurface tethers could connect to subsurface parts of the floating bodies to mooring lines or directly to the anchor. Likewise above water tethers could be utilized.

A tensegrity structure using a plurality of rigid and flexible members may increase relative position and orientation control while maintaining desired motion independence. One such example is use of a bent elastic arm to push or pull the two bodies apart and an inelastic rope or cord to keep them from separating further than a desired distance. Tensegrity principles could also be used to create a higher moment of inertia linear structure.

It may be desirable to tailor the hydrodynamic and wind drag of the power generating buoy to be higher than that of the anchored host buoy such that as the host buoy pivots around its anchor the power generating buoy will stay consistently down stream or down wind of the host buoy. This will reduce the likelihood of tangling, wrapping, and unexpected loading conditions.

In some embodiments the power generating buoy could be moored and the host buoy attached via tether. Likewise, both buoys could share a mooring or be independently moored, In a shared mooring embodiment, different length lines can be used to prevent collision. Multiple power buoys could be attached to a single power receiving buoy or multiple buoys could receive power form a single power generating buoy.

### The Host Buoy

It will be appreciated that the floating WEC and tether system disclosed herein may be deploy with any floating body, whether a “buoy” or otherwise. This disclosure focuses on observation buoys in particular because of their particular needs.

### Meteorological Masts

Meteorological masts provide instrumentation to measure wind speed and direction, among other weather variables. Offshore met masts in 30 meters of water currently cost up to $15 million while only measuring winds up to 100 [1] meters using a distribution of instruments along its height. This doesn't characterize the full 150-meter height of modern wind turbines and only provides data at discrete elevations. These met masts are not an optimal solution because of the cost, planning, and time to install. A mast typically takes up to a year to get a permit and around 3 to 6 months to build. In addition, there are significant costs to operate, maintain and decommission met masts. They also only cover a small area in a potential wind farm site. Deepwater floating wind sites, of special interest off the US West Coast, cannot be characterized by standard met masts due to difficulty of deployment in deep water.

Many observation buoys collect meteorological and oceanographic (MetOcean) measurements to support ocean observing needs and scientific research. These buoys deploy sensors above the water surface to collect meteorological data; they also deploy sensors below their hulls, on their mooring line, and/or on the mooring base. Such requirements are not compatible with installation of a depth tube required for an integrated WEC. Many observation buoys include wave spectra sensors that analyze inertial motion of the buoy for wave measurements, which might be compromised by hydrodynamic effects caused by an integrated WEC. Available real estate is often limited due to large numbers of sensors, communications equipment, and power sources located above, below, and inside the buoy. In many cases, buoys are tethered to the sea bottom with taut or catenary mooring lines, which cannot be used in tandem with a WEC depth tube. These considerations led to the concept of having a smaller, floating WEC tethered separately from the observation buoy.

The graphic in FIG. 1A displays an example of a National Science Foundation (NSF) Ocean Observing Initiative (OOI) surface buoy. There are several instruments directly beneath the buoy, including fluorometers, dissolved oxygen, nitrate, spectrophotometer, and Conductivity, Temperature, Depth (CTD) sensors, among others that could be displaced or impacted if the WEC was mounted central to the buoy (Ocean Observatories Initiative, 2020). Most OOI moorings were designed to be used with stretch hose moorings to provide transmission of power and data between the buoy and submerged sensors.

These buoy systems typically have a need for auxiliary power in the range of about 50-500 Watts. This additional power could be used to increase communication and data transmission, power additional sensors, or extend mission duration. Integrating a WEC within the structure of these buoys would require undesirable redesigning, replacing, or modifying dozens buoy systems that have undergone years of development. A retrofittable tandem floating WEC system, such as disclosed herein, would have much higher adoption rates.

Floating LiDAR buoy can be rapidly deployed and begin collecting data immediately, which is significant advantage over meteorological masts. They offer substantial advantages in terms of cost and can measure wind data at heights up to 200 meters with much better resolution than a met mast over the measurement elevation range. Floating LiDAR buoys are reusable, cost between $1-1.5 million, permits take less than 30 days, can be deployed in a day, and can be recovered (decommissioned) in a day [2]. Floating LiDAR systems also have the flexibility to move and gather additional meteorological and oceanographic data in the surround environment across multiple locations compared to a fixed met mast. LiDAR Buoys have been used increasingly frequency.

LiDAR Buoys are a subset of observation buoys with a very specific use case; these buoys collect a comprehensive set of MetOcean measurements needed for offshore wind resource characterization. The main instrument is the Light Detection And Ranging (LiDAR) sensor, which can measure wind speed and direction at a number of heights based on Doppler frequency shift analysis of transmitted and received light, up to approximately 250 m above the sea surface. The Pacific Northwest National Laboratory (PNNL) operates two modified AXYS WindSentinel™ buoys for the U.S. Department of Energy (DOE) to support offshore wind resource characterization in areas targeted for offshore wind development (Gorton & Shaw, 2020).

LiDAR systems have motion compensation algorithms to account for buoy motion, but excessive induced motion can lead to higher turbulence intensity estimates (Kelberlau, Neshaug, Lønseth, Bracchi, & Mann, 2020). LiDAR buoys also go through extensive testing and validation rounds to achieve a Carbon Trust certification “to increase confidence in the wind industry with regards to the performance and accuracy of floating LiDAR technology, in the context of wind resource assessment campaigns, when used to support final investment decisions for proposed offshore wind farms” (Carbon Trust, 2018).

More power would be beneficial to these buoys; auxiliary power in the range of 100 W to 1 kW could be used for additional sensors and increased communications, as well as adding power redundancy to their system. Maintenance costs are one of the largest expenses for buoy operations, with service trips costing $15,000-$25,000 per day for multi-day trips. Accurate knowledge of the response of the LiDAR buoy to wave motion is necessary for accurate and reliable wind and wave measurements, so a WEC power source should aim for a negligible effect on LiDAR buoy motions. Some LiDAR buoy manufacturers expressed concern that any wave energy converter formfactor could induce excessive motion in the buoy, impacting LiDAR data.

In some instances, LiDAR buoys are deployed in remote areas with deep water. Servicing of these buoys requires advanced planning, on the order of weeks or months, depending on prevailing weather conditions. In the event of a primary power system failure, the secondary and reserve power systems may not be able to keep data and communication systems functional while an emergency service trip is being commissioned. The resulting gaps in data can lead to an incomplete data set and/or a requirement for extended deployment, causing delays and financial losses. Access to an additional auxiliary power unit such as a WEC can help mitigate these risks.

The systems disclosed herein address these concerns.

Challenges faced by LiDAR buoys include motion and power.

Motion of the buoy can induce error in the data collected by the LiDAR module over a 4 to 10 second period. There are two main methods to account for motion: This first is to create a large platform that dampens the motion of the LiDAR by absorbing the surrounding energy. These involve the use of a spar or tension leg buoy design. While these types of buoys offer stability, they are expensive and difficult to redeploy. Another option is to use a smaller buoy that includes mechanical motion damping, algorithmic motion compensation, or a combination of both. These are the most common type of system as they are most cost effective and easy to deploy but lack the necessary power storage and generation capability.

The LiDAR module itself requires a consistent power draw of 45-100 watts, not including secondary systems such a communications and other meteorological sensors. Consequently, one of the more successful systems to be deployed relies on an integrated diesel generator that satisfies a total system power demand of up to 500 W or even up to 1 kW.

Most manufacturers rely on renewable power systems such as solar panels and small-scale wind turbines. However, these often fail to consistently meet the power needs. Solar panels may be susceptible to water impact damage if not adequately protected, and bird fouling and marine growth can seriously degrade performance. Performance of on-board wind turbines can be less than anticipated and may be affected by aerodynamic interference from the buoy structure itself. Solar and wind resources are highly dependent on weather and seasonal changes. Liquid fueled generators require regular refueling and maintenance, are susceptible to failure during major weather events, and are environmentally harmful with emissions. Fuel cells have been experimentally implemented by LiDAR buoys but are not in widespread use.

### Carbon Trust

In November 2013, the UK-based Carbon Trust Offshore Wind Accelerator (OWA) program published a Roadmap for the commercial acceptance of data from Floating LiDAR buoys. The purpose of the OWA is to foster collaborative R&D to reduce the cost of offshore wind, overcome market barriers, develop industry best practices, and trigger the development of new industry standards. In 10 years the OWC has contributed to a 15% reduction in the levelized cost of energy from offshore wind. The Roadmap was the first time a major organization had set out a clear set of performance expectations for floating LiDAR systems. It includes recommendations for:

Clear performance indicators, outlining acceptable standards of accuracy and data availability, allowing for equal assessment of all floating LiDAR systems.

The number of trials required before these systems can be accepted as having completed the full Roadmap (Stage 3).

Best practices to ensure successful deployments.

Wind data from floating LiDAR systems that have achieved Stage 3 status can be confidently used by developers of and investors in offshore wind projects.

### Examples of LiDAR Buoys

The AXYS WindSentinel FLiDAR is the most prevalent LiDAR used today. Based on a 6-meter NOMAD buoy hull, these buoys were designed to support the long term, consistent operation of offshore LiDARs while also integrating a wide range of sensors to provide comprehensive environmental information at the site. Sensor suites commonly include: wind speed, direction & gust, significant and max wave height, atmospheric pressure, air temperature, water temperature, dissolved oxygen, conductivity, wave period and direction, position (GPS), current speed & direction, and relative humidity. The WindSentinel FLiDAR buoy has its power supplied by a combination of solar panels, wind turbines, a diesel generator, and rechargeable lead acid batteries. AXYS FLiDAR buoys are available in a 6-meter and 4-meter format.

Another popular buoy choice is the EOLOS FLS200, supplied by solar panels, wind turbines, and batteries. It uses a ZX 300M LiDAR and also measures wave height, wave periodicity, current flow, water and air temperatures, etc. It communicates by Satellite, 4G and WiFi.

Increasing the power budget available to LiDAR buoys with a WEC allows for more data to be collected and transmitted, increased reliability, longer missions, reduced maintenance, and removal of environmentally harmful power sources. While wind and solar are common renewable energy sources for LiDAR buoys, they struggle to provide the necessary power and their output is intermittent based on length of day and changes in weather. A WEC can complement wind and solar by providing continuous baseline power. In higher Northern or Southern latitudes, wave energy is more abundant in winter months when solar power is reduced, with the opposite being true in summer months.

LiDAR buoys play a significant role in characterization of offshore wind energy and can expedite the process for wind farm permitting and installation. This data is critical to securing the funding necessary to develop offshore wind installations. Improved offshore wind resource and site characterization allows for design optimization, capital cost reduction, increased safety, and the reduction of preconstruction estimate uncertainty, which can result in a reduction in financing costs. The development of techniques for extracting turbulence information in addition to winds from the LiDAR buoys provide previously unavailable observations to inform research, engineering for loads, and industry standards. [6]

Offshore wind farms can have a meaningful impact for the American public by providing reliable renewable energy allowing for reduced reliance on fossil fuels for power generation. According to the Department of Energy, offshore wind has the potential to provide more than 2,000 GW of capacity, nearly double the nation's current electricity use. Even if only 1% of that potential is captured, nearly 6.5 million homes could be powered by offshore wind energy within the next decade. The American Wind Energy Association has noted that industry is in an incredible growth period, with a projected $70 billion business pipeline in the U.S. by 2030. In addition, developing 8,000 MW of offshore wind from Maryland to Maine by 2030 could create up to 36,000 full-time U.S. jobs requiring a diverse workforce of different occupations from engineers to pipefitters. The technology disclosed herein can play a pivotal role in growing this market and spurring job growth.

### The Power-Generating Floating Buoy

Above some of the buoys and challenges associated therewith are disclosed. We now turn to the power generating bouy, itself.

As noted above, the power-generating buoy can use any power generation method or combination of methods, including but not limited to, WEC, solar, wind, fueled-generator, etc. For example, solar can be easily added to almost any other type of power-generation method.

Any small-scale wave energy converter (WEC) may be used to provide significant power to LiDAR (or other observation) buoys. The WEC buoy concept disclosed herein is designed as an add-on to existing observation buoys, with a focus on extending deployment time by providing auxiliary power without impacting the motion of the observation buoy. The WEC buoy concept disclosed herein can generate power from 100 to 500 kW or more, depending on the needs of the host buoy.

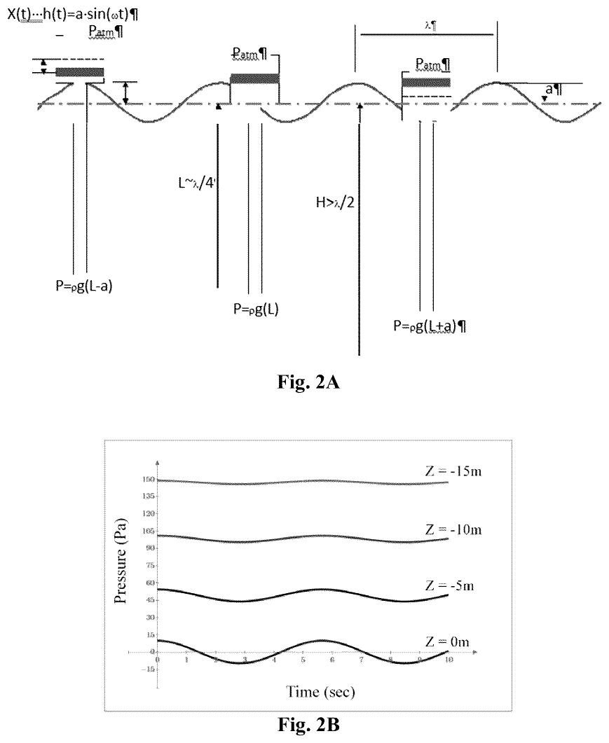

This WEC is a point-absorber type, piston-driven WEC that can be integrated with a LiDAR buoy. It takes advantage of the heave motion of the waves to create an oscillating water column to drive a mechanical piston linked to an electrical generator. The oscillating water column is created by a tube that extends from the buoy to a depth where the effects of surface waves have been largely attenuated. This is typically a depth greater than ¼ wavelength of incident waves for waves in “deep water”, where the ocean depth exceeds ½ of the wavelength. The depth pressure below this “wave base” is nearly equal to the constant hydrostatic pressure based on the mean depth and is not significantly influenced by the passing wave trough or crest. This is illustrated in FIG. 2A and FIG. 2B for waves having 2 m height and 50 m wavelength. In this case where ¼ wavelength is equal to 12.5 meters, the variation of pressure at depth is almost completely attenuated.

The dynamic portion of depth pressure can be expressed as:

$${P}_{d} = ρ \frac{{ω}^{2}}{k} h ( x , t ) \frac{cosh [ k ( z + H ) ]}{sinh ( kH )} \qquad ( 1 )$$

where ρ is density, ω is the wave frequency, h(x,t) is a periodic function used describe wave height with respect to the mean water surface, z is depth with respect to the mean water surface (positive upward), H is the mean water depth, and k is the wave number, which is dependent on wavelength, λ. The first portion of the equation is a simple periodic function. The second part is equal to 1 when z=0, and rapidly decreases toward zero as z approaches H. Values at z=λ/16, λ/8, and λ/4 are 0.45, 0.21 and 0.04 respectively. This implies that a WEC having a tube length of only λ/8 will gather about 80% of the energy that would be gathered with a tube length of λ/4. Tube length is an important design parameter and there may be significant engineering and operational benefits to using a reduced tube length that justify the resulting small reduction of power generation.

Since the tube is attached to a buoy that rides on the wave, the bottom end of the tube will experience an oscillating pressure while the upper end is exposed to constant atmospheric pressure. This process, illustrated schematically in FIG. 2A and FIG. 2B, creates a periodic pressure difference that drives the height of the water column in the tube. The potential then exists to locate a piston at the water free surface in the tube and to link the piston motion to an electrical generator.

The water free surface in the tube will oscillate through an elevation change equal to the wave height. It is impractical to build a WEC that works with a stroke on the order of 1 m or more, so a larger diameter WEC piston and cylinder configuration is added at the upper end of the tube. Based on conservation of mass, a 1 m displacement of water in a 10 cm diameter tube is equal to a 11 cm displacement of a 30 cm diameter piston.

This WEC design is similar to the IPS wave buoy [3] developed in the early 1990s. This WEC design has been extensively analyzed by several researchers including Antonio Falco and collaborators from the Technical University of Lisbon. Analysis for the WEC system is adapted from the methods developed by Falco. [4&5]

The motion of the piston may be calculated from a force balance on the piston. There are several forces that act on the piston, but the principal forces include the net pressure acting on the piston, force from the electrical generator that are proportional to piston velocity, and force from a spring element that is proportional to piston displacement. The spring is an optional element in the power takeoff (PTO) and acts as an energy storage device that helps tune the WEC to work in a particular wave state.

Piston motion will increase dramatically when the wave frequency is near the natural frequency of the WEC. This will happen over a small range of wave periods (generally less than a second) so it is impractical to design for operation at resonance. The WEC must be designed to maximize power generation at off-resonance conditions and prevent damage to the PTO when near resonance. It is clear from Eqn. 3 that the natural frequency depends on the spring constant, piston and tube areas, and the tube length, but it is independent of damping provided by the generator. It is possible to limit piston motion when near resonance by increasing generator damping while generating peak power.

One suitable Wave Energy Converter is technically a tail tube WEC, based on research of Antonio Falco (University of Lisbon). At the top end of the WEC is a piston attached to a linear to rotary conversion system with a generator. Motion of the piston corresponds to generated electrical power. The device has a depth tube that extends below the wave base to access a pressure at water depth. As the device moves vertically with passing waves, the pressure at the bottom of the depth tube changes. This leads to a differential pressure driving the piston. The overall system, power level, and application are unique. The system described herein uses a stretch hose to provide power and data between two floating bodies.

A point-absorber type of WEC that uses a hydraulically driven power take off to translate the energy of wave motion to create rotary motion that generates electricity may also be used. Power conversion electronics employ a custom control strategy to maximize power output from the inherently irregular input of the ocean waves to charge battery banks that provide a steady output of power for LiDAR buoy instruments, data storage, and communications systems.

To generate small-scale power, in some embodiments, the floating WEC utilizes an oscillating water column design, leveraging the differential between atmospheric pressure and the hydrostatic pressure of water at depth to drive a linear-to-rotary electrical conversion system. A depth tube extends below the wave base to a stable depth pressure with minimal influence from surface waves. As the vertical position of the WEC oscillates due to passing waves, the open bottom end of the depth tube correspondingly changes position, generating a pressure variation that drives the power takeoff.

The WEC buoy concept was developed into two prototype assemblies for a TEAMER project, Biofouling Analysis for Wave Energy Piston Design. This experiment, in collaboration with PNNL, quickly exposed issues with the piston seal design. The piston and seals were modified for a scaled wave tank model that was tested at the University of New Hampshire's wave tank. The tank testing yielded some promising initial results, while highlighting several areas for improvement for the next generation design.

Robust mathematical models have been developed to run complex simulations, and downselect mechanical and electrical designs for a 100-200 Watt system and eventually up to 500 Watts. The system is scalable to meet the desired electrical demand.

The investigation also identified the unique requirements of LiDAR buoys. LiDAR WEC Buoy should not impart dynamic buoy motion to maintain LiDAR buoy measurement fidelity and meet regulatory certifications. The most critical certification being from the UK-based Carbon Trust, which verifies that measurement data recorded using a particular floating LiDAR technology is reliable and can be used with confidence by investors in commercial-scale offshore wind projects.

The feasibility of scaling the WEC to provide significant power to LiDAR buoys was assessed by performing mathematical analysis and conducting thorough scaled wave tank testing.

### The Tether

The tether may be any suitable structure that physically and hydrodynamically separates the power-generating buoy from the floating host body. The tether may be fully flexible, or contain rigids sections connected via flexible sections or hinges, bearings, or other motion allowing connection. The tether allows for the connected bodies to be physically and hydrodynamically separate from one another. This arrangement and construction, among other things, prevents the two bodies from physically contacting one another, allows each to heave and fall with the waves independently, allows for freedom of movement in multiple directions to accommodate the movement of each body with the water and other elements. The tether also is adapted to transfer power from the power-generating buoy to the floating host body. In some embodiments, the powered buoy and tether are adapted for quick connection and disconnection to a suitable floating host body. This may be through a retrofit securing system or may be built into the host body.

Although other systems were tried, we focus here on an elastomeric, compliant tether design, which allows for coupling of a floating WEC to a buoy with minimal modifications to the buoy.

The compliant tether is based on EOM Offshore's stretch hose technology (Aubrey et al., 2020, 2021). The stretch hose is a compliant electromechanical cable that enables constant delivery of data and power between components in variable and extreme weather conditions. They are made of rubber compounds, interwoven with aramid fibers to create an elastic, yet incredibly strong, compliant hose, designed to stretch to two-and-a-half-times its resting length. Hoses are designed to last for several years and can undergo up to six million cycles per year. Current uses of the stretch hose are primarily for coastal observation systems where power from the buoy can be transported down the hose to submerged sensors with data transmitted back to the surface buoy for later transmission to shore. One of the longest uses of the elastomeric hoses in coastal ocean observation is the Northeast Gateway (NEG) project, which has a permit requirement for ten permanent buoys along the traffic lane separator for Boston Harbor approaches (Aubrey, 2022).

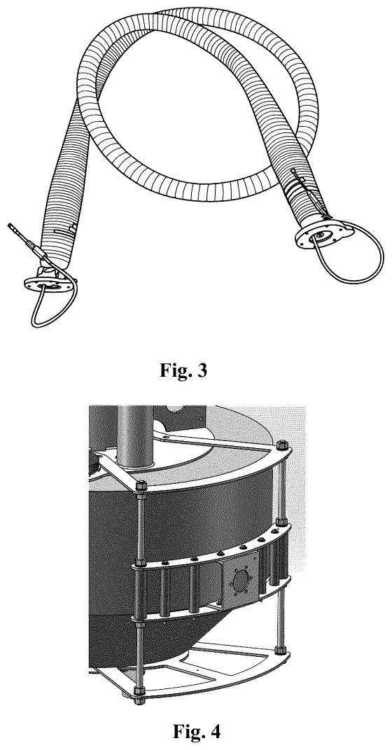

For the systems disclosed herein, a 5 m long compliant tether, shown in FIG. 3, was made to connect the WEC to an observation buoy. The hose is terminated with aluminum flanges and McArtney MCIL connectors; these flanges mate with similar connections on the observation buoy and floating WEC. 4 shows an example of a retrofit of an observation buoy: a side bracket mounts to existing anchor points, providing a secure mating interface for the compliant tether. Any suitable support bracket may be designed keeping mind the geometries of the buoy in question.

Elongation tests were performed on each stretch hose to verify its tension/elongation behavior. During testing, one end of the hose is attached to a deadweight (1-5 tonne anchor) and the other end to a fork-lift. Beginning with the hose in a relaxed state, the fork-lift moves forward in one-foot increments to a maximum additional stretch of approximately 100%. The tension in the hose is recorded by a tensionmeter attached between the anchor weight and the hose end. This process is repeated several times until the tension-elongation curve stabilizes.

TABLE 1
Test Loads for Compliant Tether

| | Stretched | Tether | Tension |
|---|---|---|---|
| | Length (m) | Stretch (%) | (N) |
| Pre- | 7.49 | 49.8 | 6382 |
| Stretch | 7.49 | 49.8 | 5915 |
| Alignment | 7.49 | 49.8 | 6060 |
| | 7.49 | 49.8 | 5815 |
| | 7.49 | 49.8 | 5804 |
| Testing | 5.49 | 9.7 | 1627 |
| | 6.00 | 19.9 | 2544 |
| | 6.50 | 30.0 | 3272 |
| | 7.01 | 40.2 | 4160 |
| | 7.49 | 49.8 | 5427 |
| | 7.98 | 59.5 | 8665 |
| | 8.46 | 69.2 | 11748 |
| | 8.97 | 79.4 | 16841 |

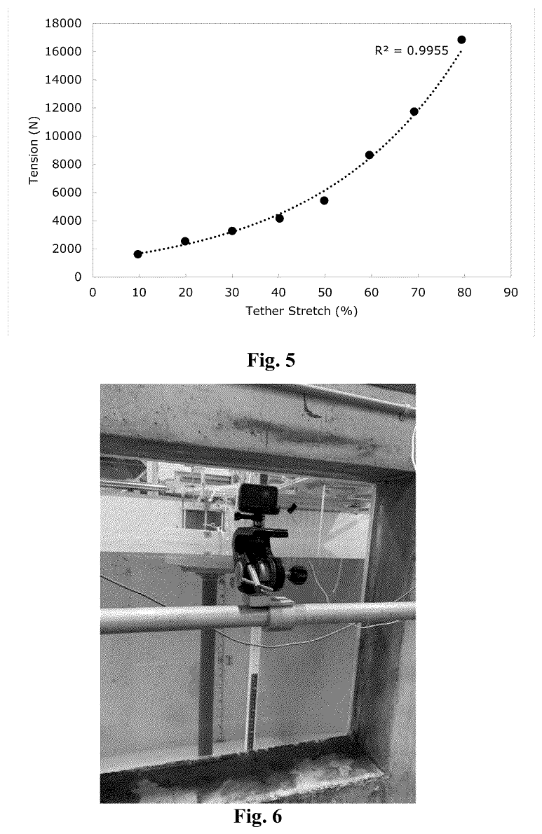

During testing of the WEC compliant tether, the hose was initially stretched 50% and then relaxed five times in succession, to align the rubber and the strength members in the hose (pre-stretch alignment). The hose was then stretched at increments of 10% of its relaxed length, up to a full stretch of 100%. At each 10% stretch increment, the hose length and tension were recorded, and then the hose was relaxed to an unstretched state, whereupon the next level of stretch increment takes place. Ancillary measurements include the circumference of the hose measured at three locations before and after the stretch, to assure the hose recovers to near its original geometry following the stretch test. The results of this test are shown in FIG. 5 and Table 1.

### 3 Methods, Assumptions, and Procedures

### 3.1 Wave Tank Modeling

The development of an effective wave-tank modelling campaign is an essentially iterative process that requires balancing a range of factors including the cost of the model, the characteristics of the available wave-tank, the duration of the testing campaign and the quality of the data produced. Because the wave tank model design is iterative only the initial factors that should be considered in the development of the wave-tank modelling, with the necessary compromise decisions regarding the actual model design and testing being made through the model design process. However, the primary requirement of the wave-tank testing is that it achieves its objectives, and this requires that the objective of the testing is clearly specified. Without clear objectives there is a lack of focus for the model design, which often leads to reduction in the quality of the wave-tank data.

A particular requirement is to prioritize the objectives from the wave-tank testing as it is easy to overreach in the testing, leading to an overall reduction in the quality of the test data. The key and overriding objective for the wave-tank modelling during the early-stage development of a wave energy concept is to provide validation/calibration of the numerical modelling and simulations; any other objectives should have a lower priority than this fundamental objective. Indeed, with limited resources it is suggested that this is the only objective of the initial wave-tank testing campaign. The validation/calibration of the numerical models then allows them to be used with additional confidence to investigate alternative configurations or control strategies.

Typically, this early-stage validation can be separated into two phases; the first phase provides validation that all of the critical physical dynamics are included in the model, whilst the second phase provides validation of the forces and motions of the wave energy converter, which often includes numerical model calibration.

The first phase can typically be satisfied by visual observation of an appropriately scaled model in the wave-tank to confirm that the relevant dynamics are included in the numerical model. For example, some heaving buoys are known to have problems with parametric excitation in pitch, through coupling with a change in the pitch stiffness of the buoy due to movement of the center of mass. However, this parametric coupling is often not included in the model due to the linearization of the hydrodynamics, which facilitates the generation of the hydrodynamic coefficients. Thus, it is important in this first phase of wave tank testing that the potential for these unexpected dynamics is not artificially suppressed by how the model is constrained. That is, at least during the first phase of model testing the model should be constrained using a mooring configuration with characteristics as close to the actual system as possible.

The second phase of wave tank testing requires measurement of the key forces and motions of the wave energy converter so that the power capture can be calculated. The very low powers generated in a scaled wave tank model, which may be less than one Watt, mean that direct replication of the power take off (PTO) system is rarely possible. This is recognized by the IEC Technical Specification for wave tank testing of wave energy converters (IEC TS 62600-103), which requires that the forces and displacements are measured. It is recognized that typically the PTO/control forces cannot be replicated in the wave tank, but the Technical Specification considers this acceptable provided that numerical modelling indicates that the dynamic response is not dramatically different from that expected from the full-scale device.

### 3.2 Water Column Outlet

The reduced diameter of the tube relative to the piston means that the velocity of the water in this tube will be larger than the velocity of the piston. Specifically, the velocity of the water will increase in proportion to the area ratio compared to the piston velocity. The effect of exit losses at the mouth of an oscillating water column are known to be significant if measures are not taken to reduce these losses. The standard method of reducing these losses is to provide a diffuser on the end of the water column to minimize the generation of vortices on the exit flow. A similar transition is also likely to be beneficial to power capture between the piston and flexible tube. CFD analysis of this transition may be necessary to achieve an effective hydraulic design.

### 3.3 Top Chamber Vent

For the coupling between the piston and hull to be primarily through the linear actuator it is necessary for the air volume above the piston to be vented to the atmosphere. Without a vent much of the force between the piston and hull would come from the variation in air pressure above the piston, which is likely to reduce the power capture. Ideally the air pressure above the piston would not vary with the piston motion, which implies a relatively large vent for air to enter and exit this space. It is worth noting that minimizing the variation of air pressure will also help to minimize any losses in the process of air venting.

Assuming that a large air vent with minimal pressure drop is provided in the WEC, this then presents the potential issue of water entering the chamber above the piston in energetic sea-states. In this case, it is necessary to consider how this water can be removed from the chamber above the piston and/or what impact this water may have on performance.

### 3.4 Parametric Excitation in Pitch

Many two body heaving WECs have suffered from the problem of parametric pitching. Parametric pitching is pitching that is induced by the change in pitch stiffness with the heave response of the system. It is important that the modeling undertaken does not simplify the system dynamics so there is no parametric excitation. It is anticipated that the long and flexible hose is likely to suppress the generation of parametric pitching; however, this should be demonstrated in the modeling to provide confidence that this will not be an issue with this WEC.

### 3.5 Linear Actuator Characteristics

The linear actuator will experience a large number of cycles through the lifetime of the WEC. Thus, it is suggested that the failure rate of the linear actuator is investigated and shown that during a typical deployment the probability of failure is acceptable. In addition, consideration should be given to how the remaining life of the linear actuator between deployments so that it can be changed or refurbished on a proactive basis, rather than reactively on failure. This can be captured through analysis of the mean time to failure (MTTF) and mean time to repair (MTTR), and accelerated life cycle testing through the rapid and repeated exposure to extreme operational conditions.

### 3.6 Sea-State Matching

There may be expected to be a significant variation in the wave climate between potential deployment locations of a LiDAR buoy. The suitability of the WEC for this range of conditions should be assessed to ensure that the WEC is appropriate for the particular wave climate in which it will be deployed. Consideration should be given to the potential for modifying the control strategy to account for different wave climates, as well as changes to the physical dimensions, buoyancy and mass of the WEC to help match the WEC response to the wave climate and thus improve performance in a specific use case. An example of a potential modification could be to the length of the hose, which should be relatively easy to modify, but could have a significant impact on performance when used in different wave climates.

### 3.7 Numerical Modeling

Development of a reliable numerical model is critical to the efficient design of a wave energy converter. WEC-Sim has been developed by NREL to specifically provide modelling capabilities for wave energy converters. However, the correct use of WEC-Sim requires a relatively high level of understanding of the hydrodynamics of wave energy converters and how these may be included in WEC-Sim. This is especially true of oscillating water column type devices that have some additional complications in their representation in the development of the boundary element method (BEM) models used by WEC-Sim associated with concave body surfaces, which can lead to instabilities in the generation of the hydrodynamic coefficients. However, whilst WEC-Sim is able to model a range of wave energy converters this is generally limited to those that can be represented as rigid bodies. Thus, representation of the flexible hose may be difficult to include in a WEC-Sim model. In this case it would be necessary to develop an alternative model based on the key hydrodynamic characteristics that need to be included in the model. It is difficult to determine without having undertaken physical modelling and having access to this data for numerical model validation. However, with this data it should be possible to determine hydrodynamic characteristics need to be included in the model to produce an accurate representation of the proposed WEC and therefore identify the appropriate modeling tool (which could be WEC-Sim) to use.

### 3.8 Wave Tank Testing

The characteristics of the wave-tank typically have the largest impact on the design of the model through the modelling scale that will be used. Because of the dominance of gravitational and inertia forces in the waves and WEC dynamics it is almost universal to use Froude scaling for wave-tank testing of wave energy converters. Froude scaling means that the linear dimensions will scale with the scale factor and time dimensions scale with the square root of the scale factor. These two factors are particularly important because the wave-tank will have a range of wave heights and frequencies that it can generate, and the scale factor needs to be chosen so that they are appropriate for the planned deployment.

The University of New Hampshire (UNH) wave-tank can generate waves of 2-5 seconds with a maximum wave height of approximately 0.5 meters 1. Table 1 shows how the scale chosen may influence the waves that can be modelled in the UNH wave-tank.

TABLE 1
Froude Scaling

Geometric scale

| | Tank | 2 | 4 | 5 | 10 |
|---|---|---|---|---|---|
| Min wave period | 2 | 2.8 | 4.0 | 4.5 | 6.3 |
| Max wave period | 5 | 7.1 | 10.0 | 11.2 | 15.8 |
| Max wave height | 0.5 | 1.0 | 2.0 | 2.5 | 5.0 |
| Force scale | 1 | 8.0 | 64.0 | 125.0 | 1000.0 |
| Power scale | 1 | 11.3 | 128.0 | 279.5 | 3162.3 |

The representative sea-state used in the proposal has a wave height of 3 m and a wave period of 14 seconds. For this to match the wave-tank capabilities that would imply about a 1/10th scale model. In addition, it is suggested that the full-scale buoy has a 1.4 meter diameter float and so the model would have a diameter of only 0.14 meters. Moreover, it would only generate about 0.3 Watts and so is likely to be very challenging to model. It is suggested that the representative sea-state is large for the likely deployment locations as this would only regularly occur in highly energetic wave locations and a better representative sea-state may have a wave height of 1.0 meter and a wave period of 7.0 seconds, although this needs to be determined following consultation. However, if this is considered to be representative then this would imply a scale factor of between 1:2 to 1:4,

which is also likely to require an increase in the buoy diameter to generate 1 kW. Both of these factors will increase the size of the model to be tested, which is likely to be advantageous to the model design as typically the larger the wave-tank model the easier it is to design and generate reliable results.

### 3.9 Linear Actuator

The linear actuator that was originally identified for the wave-tank model was the Tolomatic Electric Rod Actuator, which comes in a range of sizes and configurations. Identification of a suitable size and configuration requires further knowledge of the forces and motions that need to be generated, which in turn requires knowledge of the typical PTO forces that will need to be generated and the scale factor used in the wave-tank modelling. The project is not currently at a stage where either of these requirements are known and so a specific linear actuator cannot be identified. Notwithstanding, there are some general factors that need to be considered in the choice of the linear actuator.

When designing a wave-tank model it is important to not only consider the maximum force that can be generated by the PTO, but also the minimum force. A minimum force is often determined by the efficiency of the actuator and is likely to be between 5% and 10% of the maximum force. Thus, care needs to be taken in the specification of the linear actuator to ensure that it is not over-sized and so increasing the minimum force that can be applied, which for smaller waves could be larger than the optimum damping force that will be applied.

Consideration should also be given to how the damping force will be controlled. Assuming that the linear actuator drives an electrical motor, then it would be necessary to control the current through the motor to provide the required damping force, as the motor torque is approximately proportional to the motor current.

Although the use of the Tolomatic Electric Rod Actuator may best physically replicate the proposed system at full-scale, it is possible that this is not the preferred solution for the wave-tank model due to the difficulties in controlling the damping force through a drive train that contains a degree of backlash and potentially relatively significant losses. An alternative, which has been used successfully to apply a PTO force to a wave-tank model is a linear motor, specifically a LinMot linear motor. These are also available in a range of sizes and are highly controllable.

### 3.10 Electrical Generator and Control

It is likely that a permanent magnet DC motor will be the most suitable for coupling with the linear actuator if this solution is used for the wave-tank model. A large range of permanent magnet DC motors are available, with multiple sizes and torque ratings. Torque ripple, which can occur with these motors is unlikely to be a significant issue due to the expected large number of rotations, but a skewed DC motor could be selected to minimize any torque ripple.

The motor controller used with the motor needs to be capable of controlling the current through the motor in both directions and be able to absorb as well as generate power. Detailed discussions with the motor controller manufacturer are likely to be required to ensure that the motor controller can provide the functionality required for the wave-tank testing. Typically, manufacturers are not very familiar with the use of their motors/controllers for representing a wave energy converter PTO and so may overestimate the capabilities of their technology. Adequate time needs to be provided for dry-testing the motor/controller so that it can generate the force characteristics required for the wave-tank testing.

### 3.11 Instrumentation

As a minimum, the wave tank model should provide outputs of the forces and motions in the power extracting mode. The relatively high losses in the drive train, which may vary with conditions, means that it is typically inadequate to simply use the power generated by the motor as an indication of the power performance of the system (it is likely to result in a significant under-estimate of potential performance). In addition to the measurement of force and motion in the power extracting mode, it is necessary to measure the incident waves (this should be standard for the wave-tank) and record other motions of the body.

### 3.11.1 Motion Tracking

Measurement of the body motions using potentiometers (or similar) can be challenging when trying to capture all six degrees of freedom as these can influence the body response and are typically not necessary. Nowadays, video-based motion tracking equipment is relatively inexpensive and can provide high quality data. In the absence of video-based motion tracking equipment then a simple video of the body response may be considered to be adequate, especially for an initial wave-tank testing campaign.

### 3.11.2 Force Measurement

Measurement of the PTO forces should be relatively simple using a load cell. Obviously, the load cell should be scaled to provide as high resolution as possible without risking damage. In selecting the load cell rating, consideration should be given to not only the operational loads, but also the handling loads that the load cell may experience as they could be larger than the operational loads on the model. In extreme cases, where the handling loads are significantly larger than the operational loads, then consideration should be given to how these loads could be reduced, either by locking the model during handling, or by enforcing specific handling procedures. An additional factor that should be considered is the sensitivity of the load cell to off-axis loads and this should be part of the measurement uncertainty analysis.

### 3.11.3 Motion Measurement

The measurement of the PTO motion can either be of the linear displacement, or the rotary displacement of the motor (if this configuration is used). The motion measurement is likely to have two purposes:
Calculation of power extracted and
Control of PTO force

For the calculation of the power extracted either the displacement or velocity can be used to determine the motion. A range of options exist for measuring displacement or velocity and choice is likely to depend on how easily the sensor fits into the model. The measurement of displacement in particular is typically very accurate and most options should be adequate. However, some care is required to ensure that there is not any significant phase-shift in the measurement of the motion, as this will have an impact on the estimate of the power capture (unless compensation for the phase-shift is included).

The requirements for measuring the motion are likely to be more demanding from a control perspective, where the PTO force is a function of the velocity. In particular, differentiation of a displacement to estimate the velocity is likely to result in a low-quality velocity signal as high-frequency signal noise will be amplified. Filtering the velocity signal may be a solution, but will cause a phase-shift in the velocity signal, whose impact would need to be assessed. Notwithstanding, many wave energy converters are not highly sensitive to noise in the PTO force, provided that the correct amount of energy is extracted from each half-wave cycle. Assessing the extent to which aberrations in the PTO force may impact the performance of the wave energy converter should be undertaken prior to the final selection of the model and should be confirmed in dry-testing.

### 3.12 Wave Tank Testing Objectives

The availability and cost of wave-tank testing means that it is almost never possible to do all of the testing that is desired. In addition, during testing it is not uncommon for problems to occur, such as the failure of an instrument, that can further reduce the amount of testing undertaken. A clear understanding and specification of the testing objectives has been found to be vital to both design the test program, and also to deal with unexpected events during the testing quickly and efficiently, whilst ensuring that the key objectives of the wave-tank test program are achieved.

Defining and prioritizing objectives explicitly generally requires input from all stakeholders in the project and is typically an iterative process. Based on discussions held to date, the wave-tank testing objectives in priority order are considered to be:

TABLE 2
Wave Tank Testing Objects

| # | Objective |
|---|---|
| 1 | Identification of key dynamics of the system in operating seas |
| 2 | Identification of key dynamics of the system in extreme seas |
| 3 | Validation/calibration of the numerical model of the system |
| 4 | Analysis of influence of PTO characteristics |
| 5 | Validation/calibration of structural load model of the system |

The sub-sections below provide additional detail on each of these objectives, including the type of testing that could be performed to achieve the objective.

### 3.12.1 Identification of Key Dynamics of the System in Operating Seas

It is critical that any numerical model used to support system design includes all of the key dynamics in the system. To achieve this objective, the wave-tank testing should include tests with the system operating in the range of conditions that may be expected in deployment sites. Thus, this would typically involve testing with sea-states with a range of wave periods, heights and directions, but could also include testing with other potentially relevant environmental conditions

(e.g. with marine currents), although these additional conditions are rarely included unless there is a clear possibility that they may have an impact on the response.

It is important in these tests that the PTO/control of the system is reasonably approximated as this may have a large influence on the dynamics. A common case for wave energy converters, is that the control system causes a significant increase in body motion, which may subsequently result in key system dynamics that would not be identified otherwise.

### 3.12.2 Identification of Key Dynamics of System in Extreme Seas

An adequate system design must also consider the dynamics in extreme sea-states. In particular, it is important to determine whether there are any potentially damaging dynamics, such as entanglement of mooring lines or capsizing that need to be considered in the system design. In extreme sea-states the PTO/control forces are generally small relative to other forces and so to achieve this objective it is common to undertake these tests without applying a control force. “Turning off” the control force is also a common survival strategy and would need to be considered anyway as this is likely to be an operating load case due to a failure in the PTO system or otherwise.

### 3.12.3 Validation/Calibration of the Numerical Model of the System

Assuming that the numerical model of the system includes all the key dynamics, then it is important that it is suitable for estimating performance with sufficient accuracy that it can be used to investigate the effect of changes in design and different control strategies. This objective is typically achieved by testing in a range of regular and irregular sea-states and then comparing the wave-tank data with the numerical model. In most numerical models there are parameters, e.g. drag coefficients that have been defined based on historical data sets, which are not generally fully appropriate. Wave-tank tests should be designed to provide data for the calibration of these empirical parameters, which may include free-decay tests, forced oscillation tests, regular wave tests and irregular wave tests.

### 3.12.4 Analysis of Influence of PTO Characteristics

PTO characteristics have a fundamental influence on the power performance of wave energy systems and it is important that the influence of these characteristics are represented reasonably well in the numerical models. This objective is typically achieved by testing the system with a typical range of PTO characteristics. The range of PTO characteristics used in the testing should be sufficient to demonstrate the fidelity of the numerical model.

### 3.12.5 Validation/Calibration of Structural Load Model of the System

Knowledge of the loads in both operational and extreme conditions is important for the structural design of the system. This objective is typically achieved by using load cells or pressure sensors at critical locations in the structure and/or moorings, whilst operating in a range of regular and irregular sea-states and then comparing the wave-tank data with the numerical model.

### 3.13 Wave-Tank Testing Quality Assurance

It is critical that data generated through the wave-tank testing is of a high quality, with relatively low levels of uncertainty. Notwithstanding, aberrations in wave-tanks typically mean that the standard uncertainty in any data generated is unlikely to be less than 5-10%, although an exact

estimate of the uncertainty is difficult to determine since this would require multiple tests in multiple wave-tanks—something that is generally not available.

It is proposed that the best method to ensure quality in the data is to follow the IEC Technical Specifications for wave-tank testing of wave energy converters (IEC TS 62600-103), which provides guidelines on the set-up and execution of wave-tank tests. A check-list that contains the key requirements from the IEC standards is included in Appendix A.

### 3.14 Wave-Tank Resources Available

Understanding the resources available at the wave-tank is critical to the design of the wave-tank testing program. For example, there is no point designing tests that investigate performance in short-crested sea-states if the wave-tank is not capable of generating these types of waves. However, probably the most critical wave-tank resource to consider is the time available for the testing. Moreover, it is important to understand the daily set-up time required during the testing (for wave probe calibration, instrumentation checks, etc.) as well as other time activities that are commonly forgotten in the design of a wave-tank testing program such as the settling time of the wave-tank between sea states and the time required to change the set-up of the model when required.

### 3.15 Wave-Tank Test Program

Once the objectives of the wave-tank testing has been defined explicitly and the resources available known, it is possible to start developing the test program. As with the specification of the testing objectives, this is generally an iterative process and requires input from all stakeholders. It is typically convenient to separate the test program into n days as each day would typically start with calibration of wave probes and checking the instrumentation. This is also convenient because some flexibility in the length of the day may be possible and so this can help to keep to the testing schedule. Notwithstanding, it is good practice to have some contingency time scheduled into each day as wave-tank testing done under extreme time pressure is often of a reduced quality and has a much higher risk of generating low quality or even useless data (which can occur for a range of reasons including simple factors such as forgetting to turn on an instrument power supply). Although each wave-tank facility is different, a testing time of 5-6 hours per day is usually possible, which allows an hour at the start for calibration and checks and an hour at the end for contingency or optional tests.

Structuring the test program around a working day also means that progress in the testing can be assessed at the end of each day and then subsequent days of testing modified as required. Although this means that the working day may be much longer than the time in the wave-tank this has been generally found to be an effective strategy when access to a wave-tank is limited.

### 3.16 Wave Tank Model

Based on the research presented in the previous sections, we developed a scaled wave tank model for testing at UNH's wave tank. This model has a 12″ diameter piston and all critical features that are found in the original concept design.

### 3.16.1 Buoyancy Foam

The model's buoyancy is provided by Last-A-Foam Rigid Polyurethane Foam. This material has a closed cell construction and is normally used for boat core material or modeling. we purchased this material in 2 ft×8 ft sheets and cut profiles with a waterjet machine. This material has a 6 pound per cubic foot density. Since a cubic foot of freshwater has a weight of 62.43 lbs, each cubic foot of foam provides positive buoyancy of 56.43 lbs. the wave tank model had a total of 2.18 cubic feet of foam for a total buoyancy of 122.8 lbs. The total system weight was 97 lbs.

The system was made up of multiple sheets of foam, which gave us the ability to adjust buoyancy during testing; however, this was not utilized.

### 3.16.2 Representative PTO

For the wave tank testing model, we developed a representative Power Take Off system that uses a linear rail attached the piston. A brass rack is attached to that rail and drives a pinion installed on a brushed DC gear motor. A string potentiometer is attached to the linear rail to allow for tracking of piston displacement and speed.

### 3.16.3 Instrumentation

A large amount of data was captured through instrumentation of the wave tank prototype during testing. The final data files totaled over 200 GB. The main areas of interest were the buoy motion, piston motion, tube pressures, tube forces, and power produced by the gearmotor.

A string pot was used between the top plate of the buoy and the piston to track is motion. A hole was drilled through the piston and a differential pressure transducer was placed between the piston and atmosphere. This gave us a reading of the water pressure at the top of the tube and subsequently the total force acting on the piston. A compressive load cell was placed in-line between the piston and the linear to rotary converter (rack and pinion, in this case) to measure the force transmitted to the gearmotor. Finally, in some tests, the gearmotor leads were attached across a 2.252 resistor and the voltage drop was measured.

The various instrumentation devices were recorded using a Measurement Computer USB-1808X 8 Channel 18-Bit data acquisition module. Instrumentation voltages were measured at a rate of 100 Hz which provided ample data resolution. During some tests, the data from the differential pressure transducer was extremely noisy. This may have been due to some water from the wave tank getting inside the diaphragm of the sensor. In these cases, a moving average was used to smooth the data out. A moving average in this case behaves as a rudimentary low-pass filter. Data from these instruments can be seen in the “Wave Tank Testing Results” section.

### 3.16.4 Depth Tube

A full-size concept will utilize an stretch hose for a depth tube, but for wave tank testing purposes a rigid PVC pipe was used. This change allows for a simpler WEC-Sim and mathematical model to be used for validation with testing results.

### 3.17 University of New Hampshire

We performed the scaled wave tank model, of the WEC Buoy concept, at the University of New Hampshire's Jere A. Chase Ocean Engineering Laboratory (JACOEL). This is the first time the Oceans Team at we utilized the marine science and ocean facilities at UNH. JACOEL is one of UNH's many marine facilities in the Gulf of Maine, which include a Marine Complex

at the mouth of Portsmouth Harbor, an estuarine laboratory at Great Bay Estuary, a remote field station located on Appledore Island in Maine, and an open ocean test site six miles offshore, in 52 m of water. The school has two US Coast Guard inspected Research Vessels, a few small boats, a surface-controlled self-propelled ROV with a video camera, and a CTD profiler and water sampling system. The Open Ocean test site provides strong consideration for future testing and phases of the WEC Buoy concept.

Within JACOEL itself, there is an Engineering Tank and Wave/Tow Tank. The 60×40×20 ft Engineering Tank is used to simulate unobstructed, open water environments. The freshwater tank is filtered twice daily through a 10-micron sand filter. The Engineering Tank includes a wall-cantilevered jib crane, with the ability to lift 2 tons. The tank has received funding from NSH and NOAA, which enabled it to expand its offering of measuring instruments.

A Wave/Tow Tank, which measures 12×8×120 ft and uses a hydraulic flapper-style wave generator that can produce 2 to 5 second waves and is able to reach half a meter in height was used. The tank does provide 90 ft of length for towing test bodies. This effort utilized the tank's ability to have the WEC buoy subjected to wave action. There is a removable beach on the opposite end of the hydraulic wave generator, which provides 92% efficiency.

As stated in this report, there was significant variation in the measured wave height along the length of the wave tank, which suggests significant reflection from the end of the wave tank. In addition, the wave tank operators were not familiar with the necessary requirements for the wave energy converter testing program. All of these, in combination with the lack of time for the calibration of the wave-tank, make the Wave/Tow Tank unsuitable for this specific effort. If this effort were to continue with the JACOEL Wave/Tow Tank, additional training considerations and system reliability would need to be ensured.

A path forward could include ensuring components in the wave-maker's hydraulic system which experience a higher probability of stress-related failures are inspected and potentially replaced prior to testing. There was visible cracking along a bracket connected to the flapper of the tank. Due to time and physical constraints, further investigation was not possible.

In addition to these two tanks, the JACOEL facility has recently acquired an Environmental Flows Water Tunnel (EFWT) with a 40 cm thick sediment bed. The EFWT can simulate both oscillatory and steady flow for the simulation of horizontal wave velocities, tidal flows, or steady currents with both high- and low-velocity magnitudes. Pistons can be forced to directly simulated observed time series collected in nature.

While there were specific challenges in utilizing the Wave/Tow Tank at UNH, the Team is optimistic about the capabilities of future partnerships with UNH's School of Marine Science and Ocean Engineering.

### 3.17.1 Motion Capture

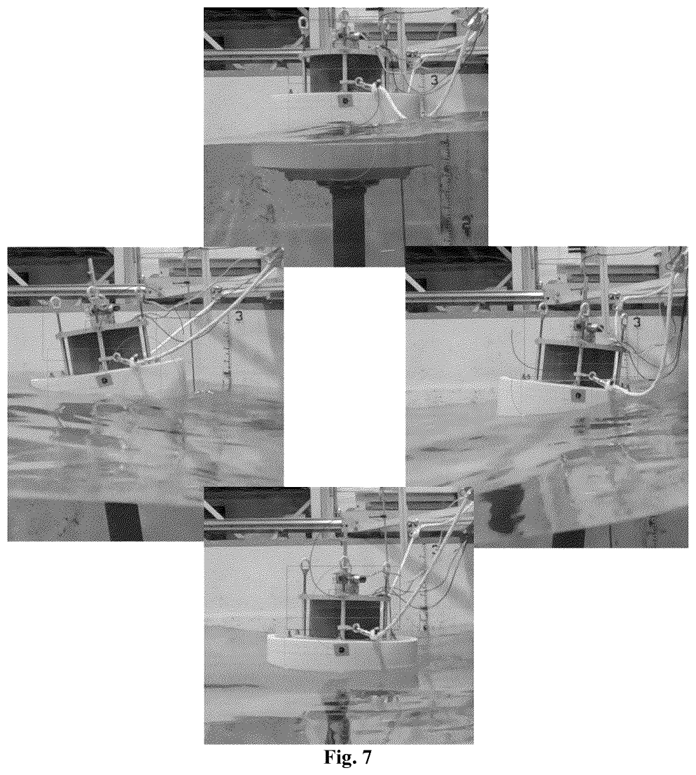

The buoy motion was tracked through a combination of video and motion capture software. Two GoPro video cameras were used on every test to capture two angles of the buoy in motion. Each test lasted around 1 to 2 minutes. Irregular wave tests were allowed to run for 10 minutes, although this was only a small number of tests. GoPro 1 was mounted perpendicular to the plane of buoy motion and was used for motion tracking. One point at the waterline and another point at the top of the buoy allowed for 3-axis Heave, Surge, and Pitch motion tracking. GoPro 2 was mounted diagonally to show the total assembly, FIG. 6. FIG. 7 shows the buoy at each position in circular movement with the wave.

The motion tracking software is a free video annotation tool design for sports analysis named Kinovea. It was recommended to the team by the wave tank operator and proved to be very effective for motion tracking. Positions are output in x and y pixel positions. Care was taken to translate these to real x and y measurements in inches. The GoPro was used in “Linear FOV”; a proprietary real-time lens correction which eliminates the barrel distortion present in short focal length lenses.

### 4 Results and Discussion

### 4.1 Teamer

### 4.1.1 Biofouling Analysis for Wave Energy Piston Design

During the course of this project, we were actively involved in a TEAMER project to study the effects of biofouling on our custom seal design. This testing was done in collaboration with the Pacific Northwest National Laboratory, conducting in biofouling tanks at PNNL's Marine Coastal Research Laboratory. A secondary focus of this testing is the performance of the seals and material selection.

We fabricated and assembled two prototypes, each with a Black amalgon cylinder, aluminum piston, custom seals, and actuator. The prototypes were then placed in biofouling tanks at PNNL, where unfiltered seawater is pumped in from the bag. During the testing the actuators drive the pistons, simulating motion from waves. Periodically, the system is inspected for wear and to evaluate the amount of biofouling. Each piston assembly has a load cell that monitors the amount of force required to move the pistons.

This testing proved immediately fruitful as a seal issue became apparent. The first portion of the testing involved a 2-week “break-in” period, where the systems were run in filtered seawater to establish the steady state baseline of piston seal friction. Over the course of that two weeks, the piston forces increased quickly until the actuators jammed at loads of 175 lbs. We investigated and determined that the vendor provided wearband was the cause of the issue. The wearband was PTFE based with 40% bronze fill, which was unknown to us before use. This wearband experienced galvanic corrosion in contact with aluminum.

To remedy this, we fabricated new wearbands out of pure PTFE. Strips of PTFE plastic were purchased from McMaster-Carr and run through a rolling hand mill to achieve the correct thickness. These wearbands were then sent to PNNL and installed in the system. The testing has since resumed.

Another issue that became apparent was an improper dynamic seal configuration. we experimented with different combinations o-ring energizers to achieve the proper normal force on the seal, but experienced issues with excessive friction. A decision was made to compromise and allow for small amounts of water to bypass the seal in exchange for lower seal friction. we will be addressing this issue with the next generation of seal design.

### 4.2 Seal Design

Test results from TEAMER, bench testing, and wave tank testing yielded several insights into the design of our seal. Moving forward, we will be consulting with A. W. Chesterton for a custom sealing solution. We will move forward with a double wear band design, one above and one below the dynamic seal.

One of the difficulties for the dynamic seal design is the tolerance range on the Black Amalgon cylinder. The inner diameter has a tolerance range of −0.000″/+0.020″. This is outside the range of traditional piston and cylinder tolerances. To get a better understanding of the situation, we will be conducting investigation using a Coordinate

Measurement Machine (CMM). CMM inspection will provide a very accurate report of the cylinder dimensions with respect to inner diameter, concentricity, taper, and parallel. These results will help us choose the proper dynamic seal.

There are two potential dynamic seal configurations that are being considered. One involves the use of a cap and o-ring design most similar to our current configuration. In this case, the o-ring provides the sealing while the cap provides a low-friction contact surface. This type of seal could have high friction forces if the cylinder does not have a consistent inner diameter.

The second design involves a u-cup design, as seen below. This seal has an asymmetrical shape with two arms that apply normal force against the piston and the cylinder wall. These seals are generally designed for situations with pressure on one side of the seal. The spring constant of the material, typically polyurethane, spreads the arms outwards. This type of seal would be more forgiving for inconsistent cylinder wall geometry.

### 4.3 Wave Tank Testing Results

### 4.3.1 Summary of Wave Tank Testing

A total of 108 tests were conducted at the University of New Hampshire (UNH).

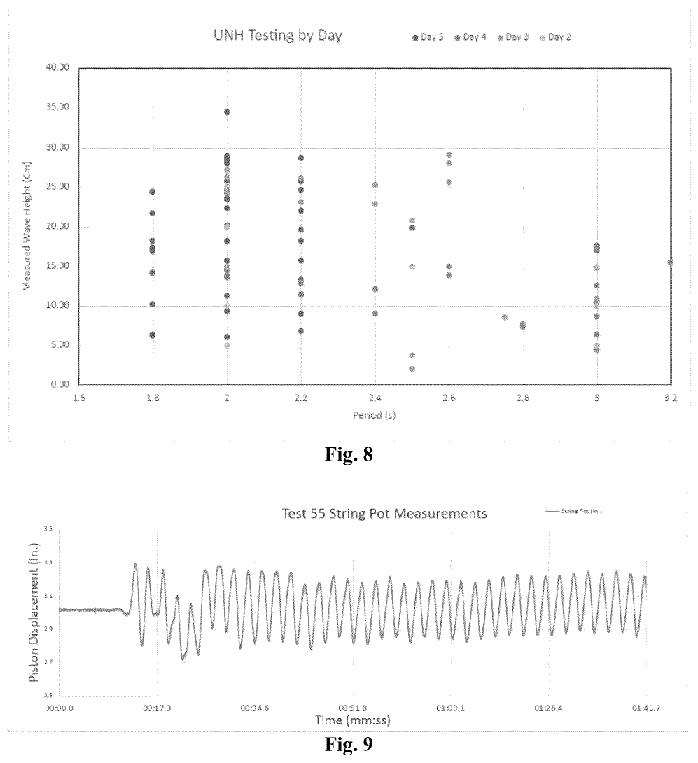

The tests were conducted at the Jere A. Chase Ocean Engineering Laboratory wave tank. These tests were conducted over a 5 day period from March 14th to March 18th. 92 tests were conducted with no PTO, and 16 tests were conducted with a PTO and power output. The number of tests can be seen in the FIG. 8 broken into days 2 through 5. Most testing was conducted around the 1.8-2.2 second wave area. This was the area where the largest amplitude waves could be generated by the wavemaker and where it had the most accurate response. This allowed for the greatest potential for amplitude sweeps.

A large amount of data was collected through instrumentation of the buoy as discussed in section 3.16.3. This includes piston motion, piston pressure, buoy motion, linear-to-rotary converter force, and PTO power output. The PTO consisted of a gearmotor attached to the linear-to-rotary

converter. Various gear ratios were selected, but only the 50:1 and 150:1 ratio could be tested due to time limitations. For non-PTO testing the gearmotor was detached from the linear-to-rotary converter.

The first 4 days consisted solely of non-PTO testing. This was intended to provide ample data on the hydrodynamic response of the buoy-piston-tube interaction with minimum impact by the PTO. The buoy motion itself was also of interest. The most useful data collected during non-PTO testing was the piston motion. A concern before testing was that substantial piston seal friction would result in minimal piston motion, if any. Regular piston motion was seen during all non-PTO testing, however. FIG. 8 shows the piston motion during typical test with regular waves, a 2.5 second period, and 20 centimeter wave height (Test 55).

The Piston Ratio, defined as the ratio between the amplitude of the piston motion and the wave height, was quickly defined to quantify the piston motion for each given test. Ideally, the piston motion for the wave tank prototype would be 1/9 or 0.111 for any wave. This comes from the ratio of piston cross-section to tube cross-section. In practice, Piston ratios from 0.015 to 0.070 were recorded with regular waves.

Tube pressure and piston force data was also collected during test 55, however, with the PTO chain unloaded the piston forces and tube pressures would quickly equalize and high forces were not seen so they are not shown here.

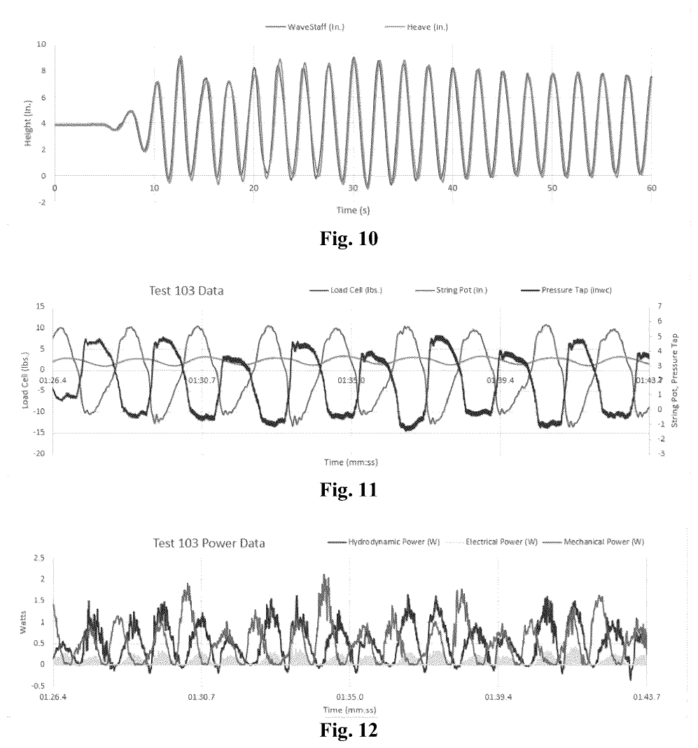

Another primary area of interest was the ability of the buoy to track the wave closely. Our system relies on the buoy to be able to match the movements of the wave to maximize the pressure oscillation at the bottom of the tube. Matching wave height data with buoy heave motion quickly revealed that the buoy matches the motion of the wave very closely. An example of this can be seen in the FIG. 10 below using data from test 55.

Tests 92-107 were all done with the PTO attached. The leads of the gearmotor were attached across a 2.252 resistor and the voltage drop was measured with a Measurement Computing USB-1808X DAQ. These tests all saw significantly higher piston forces and pressures due to the increased damping provided by the PTO. An excerpt of the load cell, string potentiometer, and pressure tap data is shown in FIG. 11 for test 103. This test was a test with 35 centimeter regular waves, 2 second period, and a 50:1 gearmotor. The load cell can be seen oscillating between +10 and −10 lbf. in phase with the wave. The pressure tap can be seen oscillating between +5 and −1 in. water column 180 degrees out of phase with the load cell.

From this data, a mechanical power figured can be derived by integrating the product of the load cell force by the string pot velocity. Additionally, electrical power can be found from the gearmotor voltage and plotted on the axes using the equation P=V2/R. That data is shown below along with the aggregate peak instantaneous power and overall average powers produced. See FIG. 12

TABLE 3
Test 103 Power Output

| — | Mechanical (W) | Hydrodynamic (W) | Electrical (W) |
|---|---|---|---|
| Peak | 2.31 | 2.58 | 0.588 |
| Average | 0.368 | 0.498 | 0.292 |

### Challenges

The number of tests could have been greatly increased if not for extensive troubleshooting at the wave tank test facilities. There were several issues with the facilities at the University of New Hampshire. The performance review of the wave-tank testing at the University of New Hampshire can be conveniently separated into two areas, the wave-tank facilities and the wave-tank model. These two areas are covered in the sub-sections below.

### 4.3.2 Testing Overview

It is RME's understanding that the key objective of the wave-tank testing was to produce data that can be used to validate the numerical model and also provide evidence that the general response of the WEC would be qualitatively similar to the assumptions used to produce the numerical model. In both cases, the wave-tank testing can be considered as a success as a reasonable amount of data has been collected and the WEC did not show any response that could be considered to invalidate the assumptions used in producing the numerical model significantly. Notwithstanding, it is best practice to review every wave-tank testing campaign to identify areas where changes could be made to improve the quality of future campaigns.

The performance review of the wave-tank testing at the University of New Hampshire can be conveniently separated into two areas, the wave-tank facilities and the wave-tank model. These two areas are covered in the sub-sections below.

### 4.3.3 Wave-Tank Facilities at University of New Hampshire

At the start of the LiDAR WEC buoy modeling campaign the wave-tank at the University of New Hampshire (UNH) had just completed a major overhaul. Consequently, there was no time for calibration of the wave-tank. Unfortunately, this meant that the demanded waves were often very different from the actual waves measured in the wave-tank. This created additional challenges in the specification of tests as well as the analysis of the data. Notwithstanding the lack of wave-tank calibration, the waves were reasonably repeatable, which was encouraging as this is a fundamental requirement for wave-tank testing.

An additional issue with the UNH wave-tank is that there was significant variation in the measured wave height along the length of the wave-tank, which suggests significant reflection from the end of the wave tank. This is compounded by the wave paddles not being “wave-absorbing”, which means that significant standing waves build up in the wave-tank. Unfortunately, the demands of testing a wave energy converter are typically much larger than for many other marine structures so that beach reflection coefficients that may be acceptable in other cases are problematic in this case. This problem was compounded at the UNH wave-tank because they only have a single wave probe and so a standard wave reflection analysis could not be done.

After two days of testing it became apparent that the wave paddles were unable to generate irregular waves. Some testing with irregular waves had been completed in the first half of the test campaign, but this issue with the wave paddles stopped further testing in irregular waves. This would have been a more serious issue if the other difficulties with the wave-tank had meant that the regular wave testing had gone smoothly. However, the delays in the test program due to the issues described above meant that only a subset of the regular wave tests could be completed in the available time. A review of the test program objectives indicates that completing the regular wave tests was the best option in these circumstances.

Although anecdotal, it seemed that the wave-tank operators were not used to working within the strict conditions required in the testing of wave energy converters. This created some tension, which could have been avoided if they were more familiar with the requirements of a wave energy converter testing program (the importance of high accuracy, low reflections, high regularity, etc.).

In summary, it is considered that the UNH wave-tank was not in a condition to undertake the quality of wave-tank testing required for this set of tests. It is suggested that this could be resolved by a national audit of wave-tank facilities to identify those that are suitable for testing the different types of wave energy converters. This could be done against IEC Technical Specification TS62600-103, which provides guidelines of the requirements of wave-tanks. Additional training for wave-tank operators that are not experienced in testing wave energy converters would also be useful so that they understand the source of the requirements for this testing and recognize that it is not simply an additional unreasonable demand of the client.

### 4.3.4 Wave-Tank Model Design

The design of wave-tank models of wave energy converters is highly demanding due to the effects of scaling friction and losses, which are typically much larger in a wave-tank model than they are at full-scale. In particular, it is extremely difficult to match the characteristics of the scale model's Power Take Off (PTO) to those for a full-scale system. Notwithstanding, the wave-tank model design enabled the response of the wave energy converter to be investigated and generate data that is suitable for validation of a numerical model.

The model instrumentation worked well, although it was disappointing that it was not possible to synchronize the signal from the wave probe to the other data channels that were collected. The motion tracking using a standard video camera appears to have worked well, although the process of extracting data is labor-intensive and ideally would be stream-lined in future test campaigns.

Unfortunately, the model PTO was not able to generate sufficient damping in the test sea-state used to investigate the effect of damping to completely identify the maximum power capture (see

Section 3.4 below). It is suggested that the PTO system used in the wave-tank model for any future test campaigns should be changed from one that closely replicates that of the full-scale PTO to a linear electrical motor as recommended in Memo #3 (TSI-5011-21-20206508-D03-RevA).

This would provide more control of the damping force so that it more closely resembles that of the full-scale PTO, including the potential for representing a range of different configurations of PTO and control strategy and thus is ideally suited for research and development.

Another minor point in the model design is that smaller diameter mooring lines would have been more appropriate as they are clearly significantly larger than required and as the lines get bigger the greater the likelihood they may affect the response of the WEC. However, in these tests it does not appear that they have had a significant influence on the test results, although removing any source that could potentially adversely affect the response of the system is clearly desirable.

### 4.4 Wave Tank Data Analysis

RME has undertaken some independent analysis of the data to support in the interpretation of the wave-tank tests. This is meant as a supplemental analysis and should be considered as additional to that already completed. In particular, it is important to note that whilst all efforts have been made to ensure the integrity of this data analysis, it has not undergone rigorous verification. Ideally, the key results should be compared to those generated independently to provide additional confidence.

### 4.4.1 Data Pre-Processing

For all analyses, except for power performance, the signals have been pre-processed to extract the primary frequency components. This has been required because of the relatively high level of instability in the responses seen, which could include both higher frequency components (non-sinusoidal response), as well as an irregular variation in the signal.

The first step of the data pre-processing was to select the last half of each set of data (with an integer number of wave cycles to minimize spectral leakage), where it is assumed that a quasi-steady state response has been reached. This signal is then detrended, to remove any offset and linear drift before a fast Fourier transform (FFT) is used to extract the frequency components. Each spectrum was then visually inspected and those with a poorly defined spectral peak at the wave frequency or other peculiarity were removed from the data set. Inspection of the signal time-series for these cases indicates that this was typically due to a poor response of the system with no identifiable regular response. The frequency component that coincides with the demanded wave frequency was then extracted and used for future analysis.

The Piston Ratio, defined as the relative amplitude of piston movement to wave amplitude, is used to provide a more robust analysis measure of response. If the system were linear then this ratio would be independent of wave height. However, it may be expected that non-linearities will cause a change in the Piston Ratio with wave height, although this should be relatively small for small difference in the wave height.

### 4.4.2 Analysis of Sensitivity to Wave Height

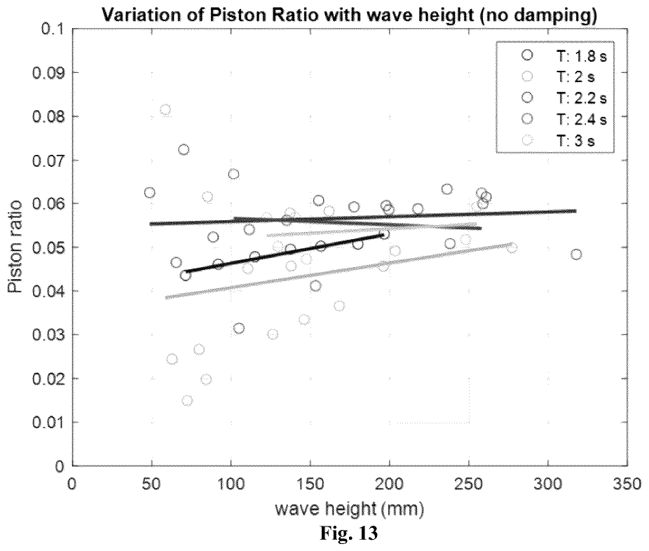

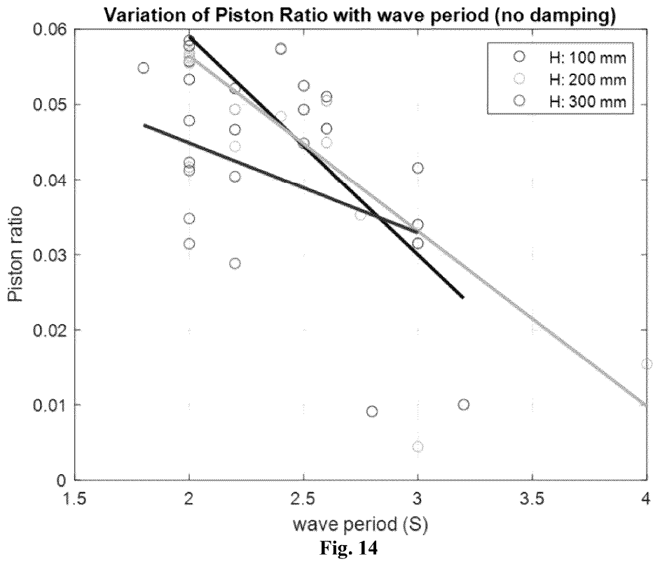

The variation of Piston Ratio with regular wave height is shown in FIG. 13 for five different wave periods. It can be seen that there is no significant variation in the Piston Ratio with wave height for all of the wave periods.

This lack of sensitivity of the Piston Ratio to the wave height suggests either that the system is linear, or that the non-linear effects of piston stiction (likely to reduce the Piston Ratio in small waves) and the effect of vortex shedding (likely to reduce the Piston Ratio in large waves) combine to result in non clear trend in the variation with wave height. However, the large scatter in the Piston Ratio for any particular wave period suggests that the response is not well defined and the approximate insensitivity to the wave height is not due to the system being linear, but rather the combined effects of stiction and vortex shedding, with stiction accounting for the large amount of scatter seen in the smaller amplitude waves.

### 4.4.3 Analysis of Sensitivity to Wave Period

The variation of Piston Ratio with regular wave period is shown in FIG. 14 for three different nominal wave heights. It can be seen that the Piston Ratio typically reduces with increased wave period for all wave heights.

Unfortunately, the combined effect of stiction and the effect of vortex shedding means that the effect of different wave heights is challenging to interpret as shown in subsection 4.1; however, the reduction in the response with wave period suggests that the wave is also exciting the water column and thus causing this to move together with the hull. Importantly, the results do not show any evidence of resonance within the system suggesting that its natural periods are outside of the range of wave periods used for testing.

### 4.4.4 Power Performance Analysis

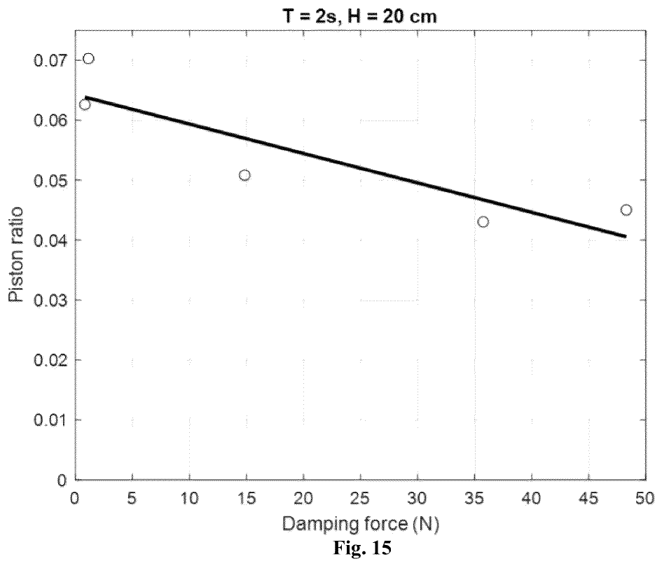

Only a relatively small number of tests were performed with some applied damping due to the delays in the testing program. The most interesting of these tests with damping, from which the power performance could be assessed was for the regular wave with a period of 2.0 seconds and a nominal (demand) wave height of 200 mm. FIG. 15 shows that the amplitude of piston movement, and thus the Piston Ratio reduces with the damping force as would be expected.

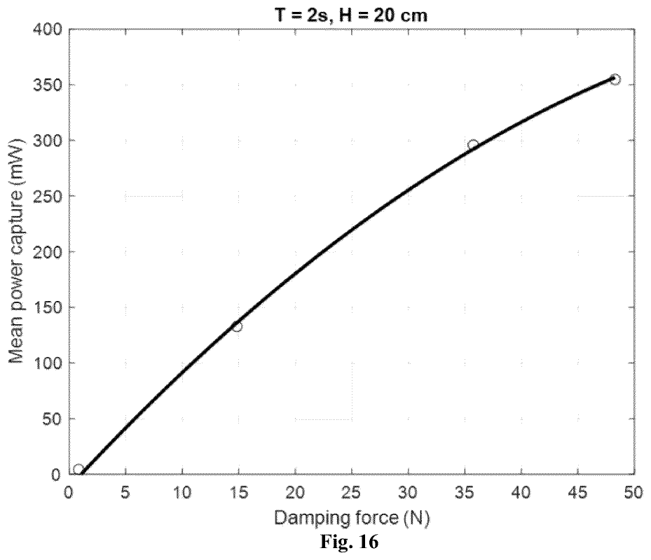

FIG. 16 shows the power capture is increasing with the damping force and does not reach a peak within the range of damping forces tested. However, clearly the power capture cannot increase without limit and a slight reduction in the power capture with damping force can be seen. This follows what would be expected, in that initially there is a linear increase in the power capture with damping force, as the damping force has a minimal impact on the amplitude of piston motion. However, as the amplitude of piston motion starts to decrease the rate of increase in power capture with damping force will decrease to reach a peak. Using the quadratic curve fitting shown this may be expected to occur at a damping force of about 80 N and result in a maximum power capture of about 500 mW.

### 4.5 RME Conclusions

Whilst this Phase I project has made significant progress in developing an understanding of the performance and design challenges of the WEC concept, further effort is required to support the effective development of the technology. This understanding needs to be developed by considering all aspects of the design, from the hydrodynamic performance, the system power generation, the cost of fabrication, and the plant reliability. Based on the progress made in this Phase I project the key aspects of this understanding that require further effort are the hydrodynamic modeling (both numerical and physical), the performance of the WEC piston seals and the design/control of the PTO (linear to rotary converters and generator).

The hydrodynamic modeling in this project has been significantly more challenging than expected for both the numerical and physical elements. Whilst the numerical modeling has sensibly been based on the WEC-Sim platform, the generation of the hydrodynamic coefficients using NEMOH has been problematic and unreliable. Problems with an open-source software such as NEMOH are difficult to resolve in the time-scale for a development project such as this and it is concluded that it would be better to generate the hydrodynamic coefficients using a commercial software such as WAMIT, which is significantly more reliable. Unfortunately, the challenges in developing the numerical model has meant that only limited hydrodynamic optimization has been possible in the project, which may mean that the potential of the concept is higher than these earlier models predict.

The physical modeling in this project has also been challenging, but it is also worth mentioning that some of these problems may have arisen from an overreach in the objectives of the wave-tank testing. Specifically, the use of a scaled-down version of the actual PTO resulted in a model that had less controllability than the use of a PTO simulator (for example a linear motor), which would be able to generate the equivalent forces of the full-scale PTO more accurately and more reliably. The likelihood of this overreach occurring could have been reduced if the objectives of the physical modeling had been stated more explicitly, including their priorities cross-indexed with potential solutions and their risks.

A final provisional conclusion for the Phase I project is that the development of a small WEC such as that proposed in the project is significantly less demanding than that for a larger or utility-scale WEC. The experience of RME is that the cost of development of a utility-scale WEC is typically in the tens of millions of dollars and requires multiple years of effort even before the deployment of a prototype. However, although significant work remains in the development of this concept it is anticipated that this should be achievable within two more years of effort and within a relatively modest budget (1-2 million dollars).

### 4.6 ProteusDS

### 1.4.2. Modeling/Simulation

### Buoy-to-Buoy Interaction

EOM Offshore performed dynamic modeling of a two-buoy LiDAR WEC system using ProteusDS, with the
following environmental parameters: Water depth:
15 m, Wave Height: 9 m, Wave Period: 15 seconds, Steady current: 0.3 m/sec, Direction of waves and current:
at 90 degrees from each other.

The components of the model included:
1. Master buoy, a NOMAD buoy, approximately 6 m long and 3.2 m wide. Mass approximately 9,500 kg.
2. WEC buoy, made of polymer, 1.5 m in diameter, with instrument well.
3. Mooring element for master: 55 m long chain.
4. Elastomeric hose 5 m length links NOMAD and WEC buoy.
5. Anchor, universal joint, and suitable cabling/connectors complete mooring.

The elastomeric hoses are stretch hoses manufactured by EOM Offshore. They are made of proprietary rubber
compounds, interwoven with aramid fibers to create an elastic, yet incredibly strong, compliant hose. The hose
is designed to stretch to 2.5× its resting length. Hoses are designed to last for several years and can undergo up
to six million cycles per year.

Modeling shows the WEC buoy follows the main buoy well, with the mooring umbilical taking up motion between the two buoys. Modeling shows the WEC buoy behaves similarly to the main buoy, and its motion is not overly affected by the main buoy. Tensions in the umbilical connector are fairly low: maximum tension is about 700 N. With the geometry modeled, at times the umbilical is under zero tension. Since the hose is elastomeric and stretchable, it responds to the tension caused by relative motion between the buoys. Under the conditions modeled, the hose only stretched by about 10% of its resting length.

### Power Generation Estimate

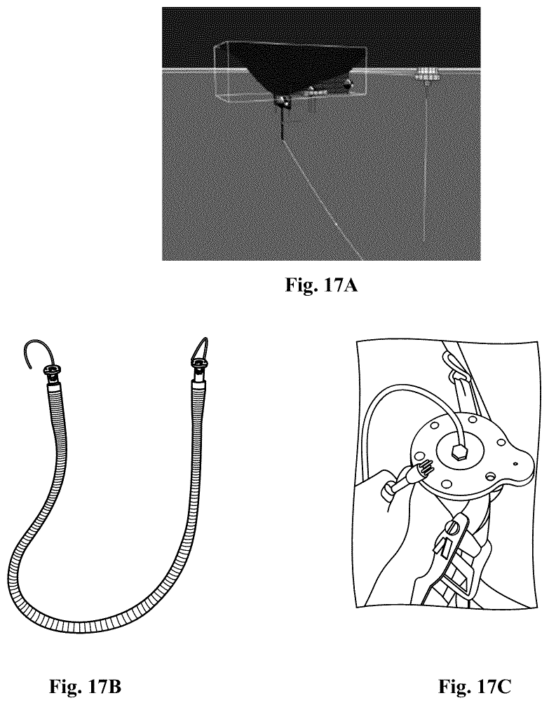

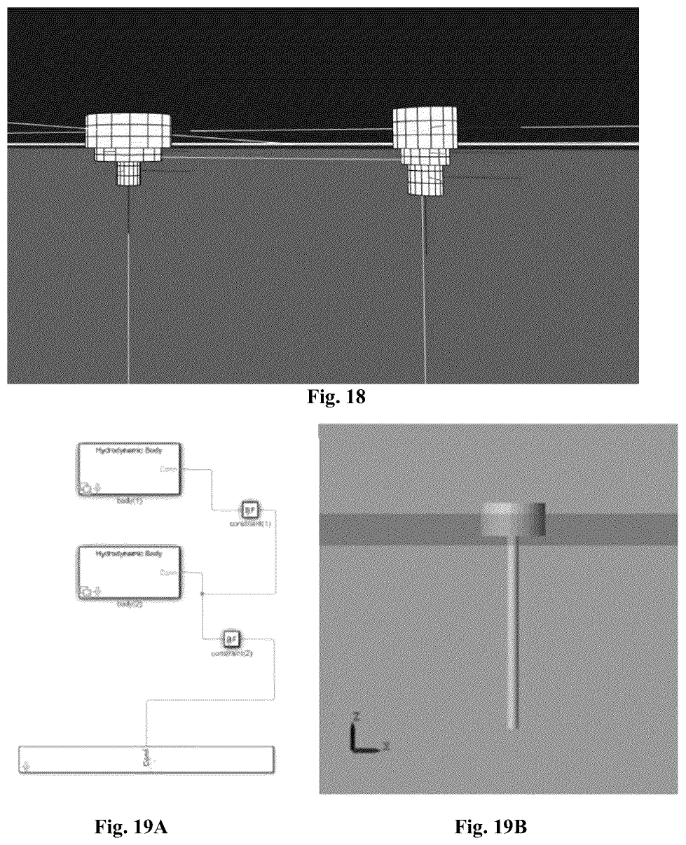

Estimates of power generation were made using models based on analysis methods for a spar buoy WEC reported in References 4 and 5. WEC power generation was estimated for 1 m wave height and wave periods ranging from 4 sec to 8 sec. Piston diameters ranged from 300 mm to 700 mm and tube diameters from 200 mm to 500 mm. Tube length was uniformly 30 m. The ratio of piston-to-tube cross sectional area has a significant effect on power generation with higher power generation as the ratio decreases to 1. This is impractical based on the cost and complexity of a large diameter tube. Power generation is also highly dependent on the natural frequency of the WEC, which is strongly influenced by the mass of moving water. It can also be influenced by the addition of a spring element in the PTO. Power generation is maximized when the natural frequency is close to the wave frequency (i.e. inverse of wave period). A spring element is a constant characteristic of a PTO, but PTO damping can be adjusted dynamically and provide a 2× variation in power output. Power generation in excess of 1 kW is estimated when operating near resonance. These estimates will be validated in Phase II using WEC-SIM modeling. FIG. 17A shows the ProteusDS Simulation with NOMAD Buoy and WEC Buoy, EOM Compliant Cable Production (FIG. 17B and FIG. 17C).

### Modeling Compliant Tether Interactions

EOM Offshore performed hydrodynamic modeling of a WEC-buoy system using ProteusDS, with the following environmental parameters:
Water depth: 15 m
Wave Height: 8 m
Wave Period: 12 seconds
Steady current: 0.1 m/sec
Direction of waves and current: at 90 degrees from each other

These environmental parameters were selected to represent storm waves that could occur on either coast of the U.S. The water depth of 15 m was selected as it is representative of the water depth where the first WEC will be experimentally deployed in September 2022.

The components of the model included:

Observation buoy (NOMAD design), approximately 6 m long and 3.2 m wide. Mass approximately 9,500 kg. Additionally, a 55 m long chain mooring element and anchor.

WEC, in floating form factor, made of polymer, 1.5 m diameter.

Observation buoy and WEC connected with compliant tether (5 m EOM elastomeric hose).

Modeling showed the floating WEC follows the observation buoy well, with the compliant tether absorbing relative motion between the two bodies. Tensions in the compliant tether were fairly low: maximum tension is between 700-1000 N. By contrast, tension in the primary mooring chain on the NOMAD buoy was approximately 20,000 N. Modeling thus shows the NOMAD's behavior is controlled much more by the primary mooring chain than by the WEC buoy. For the geometry modeled, at times the tether was under zero tension. Since the compliant tether is elastomeric and stretchable, it responded to the tension caused by relative motion between the buoys. Under the conditions modeled, the hose only stretched by 10% of its resting length.

EOM Offshore performed some dynamic modeling of a two-buoy system from which we could mount its Wave Energy Converter. The modeling was performed using ProteusDS, an advanced time-domain dynamics analysis software package that is used to test virtual prototypes of many marine, offshore, and subsea systems and technologies. The modeling was completed with the following environmental parameters: Water depth: 40 m, Wave Height: 8 m, Wave Period: 14 seconds, Steady current: 0.25 m/sec, Direction of waves and current: collinear.

The components of the model included:
Master buoy: a 1.4 m diameter high density polyethylene buoy commonly used in EOM moorings
WEC buoy: a buoy similar to the master, but 0.7 m in diameter
Mooring element for master buoy: A 30 m long elastomeric hose (stretch hose) manufactured by EOM under exclusive license was used to moor the main buoy. The 30 m elastomeric hose can stretch to 75 m at a design tension of about 50,000 N. It has a non-linear stress-strain curve to permit it to inhibit excessive stretch as the tension increases.

Mooring element linking master buoy with WEC buoy: A similar elastomeric hose as used for the mooring was used, in a 3 m length. Power and data can be transmitted through these elastomeric hoses by design: up to about 1 MW is the anticipated limit to power transmission through the hose; WECs, of course, use much less power transmission. In addition to the larger elastomeric cable, we tested a Safe-Moor hose as the linkage: this hose stretches more easily and more completely decouples the motion from the two buoys. Safe-Moor has been used successfully to moor Datawell Wave Buoys, allowing the wave buoy to serve as a slope following measurement device.

Anchor, universal joint, and suitable cabling/connectors complete the mooring.

The elastomeric hoses are stretch hoses manufactured by EOM Offshore. They are made of proprietary rubber compounds, interwoven with aramid fibers to create an elastic, yet incredibly strong, compliant hose. The hose is designed to stretch to 2.5× its resting length. Hoses are designed to last for several years, and can undergo up to six million cycles per year (a five second wave).

The model configuration is as shown in FIG. 18: the main buoy is on the left, the WEC buoy is on the right.

Modeling shows the WEC buoy follows the main buoy well, with the mooring umbilical taking up motion between the two buoys. Modeling shows the WEC buoy behaves similarly to the main buoy, and its motion is not overly affected by the main buoy.

Tensions in the umbilical connector are fairly low, as the two bodies track motions well: maximum tension is about 300 N. With the geometry modeled, at times the umbilical is under zero tension. Since the hose is elastomeric and stretchable, it responds to the tension caused by relative motion between the buoys. Under the conditions modeled, the hose only stretched by about 10% of its resting length.

Since the umbilical links both the buoys, the forces on the buoys are the tensions in the hose. Thus, the forces on the buoys are about 300 N maximum under conditions modeled. This force can be placed at any linkage point on the buoy, which can be optimized in the future to elicit the most acceptable buoy motion.

Optimizations for future modeling might include:
Buoy sizes (and relative buoy sizes)
Buoy ballast
Length of hose linking two buoys
Umbilical connector points on both buoys
Stretch characteristics of linkage hose (stress-strain behavior)

More quantitative comparison of relative motion between the two buoys, for finalized configuration (such as cross-spectral analysis).

Based on initial analysis, a compliant tether presents a promising solution to pairing a floating WEC with observation buoys without requiring extensive retrofit or impacting measurement fidelity. The design for the overall Triton WEC system, including the compliant tether, has been directly guided by frequent conversations with stakeholders in both MetOcean and LiDAR buoy networks. Regardless of merit, the oceanographic industry maintains high standards for performance and reliability; adoption of new technology requires significant experimental data and proven results.

To validate performance in a real-world environment, two open water tests are scheduled in 2022 and 2023 to analyze the full WEC system performance. Future testing through U.S. DOE sponsored programs such as Testing Expertise and Access for Marine Research (TEAMER) can specifically target validation of the compliant tether during controlled in situ tests. The final validation testing will require comparison of data collected by observation buoys with and without a Triton WEC to determine the impact of the system paired by compliant tether. In addition, further testing of the floating WEC concept will be carried out for different environmental conditions, including different water depths.

The wave-tank testing demonstrated that the WEC system disclosed herein has an acceptable dynamic response and requires minimal mooring forces and so is well suited for powering a host buoy such as a LiDAR buoy through an umbilical as this means it is not expected to impact on the stability and operation of the LiDAR measurements. A piston and seal design has been identified that provides sufficient sealing, whilst having an acceptably low level of friction to minimize power losses.

The relative complexity of the hydrodynamics of the WEC mean that an open-source code such as NEMOH may not be adequate for generating hydrodynamic coefficients and a commercial package such as WAMIT should be used

The wave-tank testing of this concept is extremely challenging, so it is important that a wave-tank facility experienced in testing wave energy converters is used in future test campaigns.

The potential applications for wave energy conversion applied to buoys can be maritime sensors, monitoring equipment, communications, and other similar payloads, AUV recharging. These WEC applications can provide solutions for offshore wind, the oil and gas energy transition, defense, ocean science market, and other offshore renewable energy markets. The floating tethered WEC system described herein has many uses and advantages. Service trip costs are quickly increasing, which increases the value of local renewable energy generation and thus the value of this concept.

An off-shore power system comprising a power generating buoy, and a tether connected at one end to the wave energy capture buoy and connectable to a floating host buoy, wherein the tether further comprises means for transferring power generated by the power-generating buoy to the host buoy; and wherein the tether is adapted to allow for independent movement of the power-generating buoy relative to the host buoy, and has no substantial hydrodynamic effect on or from the host buoy when connected.

### Embodiments

A wave energy capture system comprising a wave energy capture buoy, and a tether comprising a stretch hose connected at one end to the wave energy capture buoy and connectable to a host buoy, wherein the tether further comprises means for transferring power generated by the wave energy capture buoy to the host buoy; and wherein the tether is adapted to allow for independent movement of the wave energy capture buoy relative to the host buoy, and has no substantial effect on one or more of the movement of or measurements made by the host buoy.

An observational buoy system, comprising a host buoy that is an observational buoy, a wave energy capture buoy, and a tether comprising a stretch hose interconnecting the host buoy and the wave energy capture buoy, wherein the tether is adapted to allow for independent movement of the wave energy capture buoy relative to the host buoy, and has no substantial effect on one or more of the movement of or measurements made by the host buoy.

What is claimed is:

1. An off-shore power system comprising:
a) a power generating buoy,
b) a tether connected at one end to the power generating buoy and connectable to a floating host buoy, wherein the tether further comprises means for transferring power generated by the power-generating buoy to the host buoy; and wherein the tether is adapted to allow for independent movement of the power-generating buoy relative to the host buoy, and has no substantial hydrodynamic effect on or from the host buoy when connected.

2. A wave energy capture system comprising:
a) a wave energy capture buoy, and
b) a tether comprising a stretch hose connected at one end to the wave energy capture buoy and connectable to a host buoy, wherein the tether further comprises means for transferring power generated by the wave energy capture buoy to the host buoy; and
wherein the tether is adapted to allow for independent movement of the wave energy capture buoy relative to the host buoy, and has no substantial effect on one or more of the movement of or measurements made by the host buoy.

3. An observational buoy system, comprising:
a) a host buoy that is an observational bouy;
b) a wave energy capture buoy, and
c) a tether comprising a stretch hose interconnecting the host buoy and the wave energy capture buoy,
d) wherein the tether is adapted to allow for independent movement of the wave energy capture buoy relative to the host buoy, and has no substantial effect on one or more of the movement of or measurements made by the host buoy.
